(19) United States
(12) Patent Application Publication
(10) Pub. No.: US 2023/0304167 A1
(43) Pub. Date: Sep. 28, 2023

(54) PRODUCTION OF METAL HYDROXIDE FROM MINERAL RESOURCES AND APPLICATION THEREOF FOR CAPTURING AND SEQUESTERING CARBON DIOXIDE

(71) Applicant: PLANETARY TECHNOLOGIES INC., GATINEAU (CA)

(72) Inventors: Alexandru Vasile Mezei, Peterborough, CA (US); Mariam Melashvili, Peterborough (CA); Brock Bruno Battochio, Ottawa (CA); Gregory Hudson Rau, Castro Valley (CA); William James Burt, Halifax (CA)

(21) Appl. No.: 18/183,873

(22) Filed: Mar. 14, 2023

Related U.S. Application Data
(60) Provisional application No. 63/319,726, filed on Mar. 14, 2022.

(51) Int. Cl. C25B 1/20; C25B 13/04; C25B 9/19; C25B 15/08

(52) U.S. Cl. CPC C25B 1/20; C25B 9/19; C25B 13/04; C25B 15/081

(57) ABSTRACT

The invention describes an electrochemically enabled process for the production of magnesium hydroxide from mineral resources, using acid produced in the electrolysis cell for heap or vat leaching of the mineral resources. The process also enables extraction of nickel, cobalt, iron and silica from the mineral resources, and reduction or elimination of asbestos fiber. The produced magnesium hydroxide is used for carbon dioxide capture and sequestration from gaseous and liquid environments.

### CROSS-REFERENCE TO RELATED APPLICATIONS

The present application claims the benefit from the U.S. Provisional Pat. Application Serial No. 63/319,726 filed on Mar. 14, 2022, entitled “PRODUCTION OF METAL HYDROXIDE FROM MINERAL RESOURCES AND APPLICATION THEREOF TO CAPTURE AND SEQUESTER CARBON DIOXIDE”, the entire contents of which are incorporated herein by reference.

### FIELD OF THE INVENTION

The present invention relates to production of metal hydroxide from mineral resources and application thereof to capturing and sequestering carbon dioxide.

### BACKGROUND OF THE INVENTION

The vast majority of the prior art concerning Carbon Dioxide Removal (CDR) involves a range of methods which remove and permanently store carbon dioxide from the atmosphere. Unlike Carbon Capture and Storage (CCS) which captures CO₂ from point sources of emissions, CDR methods are strictly focused on capturing and permanently storing legacy CO₂ directly from the atmosphere. CDR includes a broad range of nature-based or engineered solutions including afforestation, increased soil carbon storage, mineral carbonation, direct air capture, and Ocean Alkalinity Enhancement (OAE). OAE is an approach to carbon removal that involves adding alkaline substances to seawater chemistry to enhance the ocean’s natural capacity to capture and store atmospheric CO₂ and help counter ocean acidification.

Magnesium hydroxide is a substance that can be used in a variety of industrial, pharmaceutical and environmental applications including OAE and CCS. It is desirable to minimize the CO₂ emissions associated with magnesium hydroxide production and use, particularly in the case of CDR and CCS to maximize the reduction of the CO₂ burden in the atmosphere.

According to the prior art, the traditional pyrometallurgical methods of magnesium hydroxide production involve energy-intensive unit operations, such as the calcination of magnesium carbonate or dolomite, which generate significant CO₂ emissions. This is because the calcination process requires high temperatures, that are often industrially achieved by burning fossil fuels, consequently releasing CO₂ into the atmosphere. In addition to the process emissions, magnesium carbonate or dolomite contain a carbon atom, and when these compounds are calcined to break down the chemical bonds, the carbon atom is released as CO₂ gas, further adding to the carbon footprint of the magnesium hydroxide production.

Ultimately, if the CO₂ emissions generated during magnesium hydroxide production exceed the amount of carbon dioxide that the compound can capture and sequester in CDR, then the process becomes counterproductive in terms of reducing CO₂ in the atmosphere. In other words, if more CO₂ is released during magnesium hydroxide production than it captures and stores, then using magnesium hydroxide would increase net CO₂ concentrations in the atmosphere. Therefore, it is required to consider the emissions associated with magnesium hydroxide production when assessing its suitability for CDR and CCS.

Furthermore, to be amenable for the purpose of OAE, it is necessary that the magnesium hydroxide be high purity. Impure magnesium hydroxide is not suitable for OAE because when introduced to seawater it would likely exceed commercial ocean disposal permitting limits and more importantly, could have a deleterious effect on the marine environment.

Magnesium hydroxide does geologically form naturally as a mineral called brucite. Natural brucite mining is typically a less carbon intensive source of magnesium hydroxide than synthetic versions, however, it is generally less reactive and can contain elevated levels of heavy metals and other impurities that may render it undesirable for OAE.

According to the prior art, production of magnesium hydroxide by hydrometallurgical processing of magnesium containing feed-stocks such as ultramafic ores and tailings can be less carbon intensive than traditional pyrometallurgical methods, low- or non-CO₂ emitting energy such as derived from solar, wind, hydro, biomass, geothermal, marine or nuclear sources.. However, the feedstocks may be severely impacted by particular compositions of magnesium-rich ores.

For example, certain widely applied industrial unit operations such as agitated leaching are unsuitable in their present form for processing fibrous materials, including but not limited to minerals containing asbestos. This has prevented the recovery of potential alkaline metals commercially to date from this category of feed-stocks.

Therefore, there exists a need in the industry for developing an improved hydrometallurgical method for production of magnesium hydroxide, which would overcome or mitigate the above-mentioned challenges of the prior art.

### SUMMARY OF THE INVENTION

There is an object of the present invention to provide a fully integrated method for producing magnesium hydroxide from mineral feed-stocks in a purified form that is suitable for the capture and permanent sequestration of carbon dioxide or for other industrial, commercial, or environmental uses while minimizing the CO₂ emissions from that production.

There is also an object of the present invention to coproduce nickel and cobalt pay metals, and hydrogen gas.

There is also an object of the present invention to sequester carbon dioxide in the CDR or CCS processes using the produced magnesium hydroxide.

In the embodiments of the present invention, more CO₂ is captured and stored by using the produced magnesium hydroxide than is emitted during production of magnesium hydroxide, meaning that when applied to CDR the overall method is net CO₂-emissions negative.

The present invention discloses a method of recovering magnesium, nickel and cobalt from magnesium silicate mineral, preferably asbestos tailing material, using sulfuric acid. The method is based on stacking the feed material or raw tailings ore in “heaps” (Heap Leaching) and installing the required irrigation system and drainage ponds. Alternatively, leaching is realized in large tanks by “Vat Leaching” fitted with a solution circuiting and storage systems. These two methods are particularly suitable for materials containing a fibrous components. In Heap and Vat Leaching, the solid material is stationary and promotes a process-friendly flow behavior in contrast to the conventional agitated-mixing processes in reactors. Additional advantages of heap and vat leaching methods lie in their relative insensitivity to the actual metal grade of the feed material and the use of relatively dilute acid solutions. Typically, heap leach operations are less capital and operating costs extensive compared to the agitated-reactor leaching.

The difference between heap and vat leaching is the direction of the flow of the leaching solution, also known as “lixiviant”. Heap leaching is based on gravity-based irrigation-flow of the lixiviant between the mineral particles that are not submersed in said solution. Vat leaching is realized by forced percolation-flow of the lixiviant through the minerals fully immersed in the lixiviant. This difference allows for building a significantly larger scale heap operations compared to vat operations.

Upon heap or vat leaching, the resulting acid leach solution is directed first to an impurity removal stage, followed by the Ni/Co mixed hydroxide recovery circuits. Each circuit requires a careful selection of the operating parameters for achieving peak productivity. The treatment of the acid leach solution in the impurity removal stage and further treatment of the processed leach solution in the Ni/Co recovery stage are conducted in well-mixed reactors and using certain alkaline reagents. In one form of the purification stage, an addition of oxidant (oxygen, air, peroxide) is required to precipitate the iron quantitively. After purification and Ni/Co recovery, the processed leach solution contains mainly magnesium sulfate, which is directed to the electrolytic cell. During electrolysis, four main products are produced: magnesium hydroxide, sulfuric acid, as well as oxygen and hydrogen gases. The electrolytically produced sulfuric acid and oxygen are used in the leaching and in iron removal stages, respectively. The hydrogen gas produced can be dried, compressed, and stored for later use as a clean burning fuel. The magnesium hydroxide produced is used for CDR or CCS. The introduction of the magnesium hydroxide into the ocean effects the uptake and storage of atmospheric CO₂, mimicking a natural process, wherein alkaline minerals react with CO₂ and water to ultimately form bicarbonate and carbonate, and ions in seawater balanced by Mg²⁺. Use of low- or non-CO₂-emitting energy sources in the production of the magnesium hydroxide would maximize the net atmospheric CO₂ benefit of the process.

The present invention proposes a hydrometallurgical process that regenerates the active agent contained in the lixiviant such as sulfuric acid, along with the active agent needed for carbonation, for example magnesium hydroxide. When present in the ore feed, nickel, cobalt, and other valuable metal concentrates are removed from the ore feed, and sold to refiners, supplying, for example, the battery-manufacturing market.

When the ore feed contains various process residues and tailings containing fiber, they are converted during the above-described metallurgical process into material without fiber content, thereby eliminating or reducing a negative environmental and health impact associated with the fiber content.

The magnesium hydroxide produced by the present invention has been added to seawater to both counteract ocean acidification and effectively capture and sequester atmospheric carbon dioxide via Ocean Alkalinity Enhancement (OAE). Alternatively, the magnesium hydroxide may be added to the land surface, soils, or inland waters (ponds, reservoirs, lakes, rivers) to effect CO₂ removal and sequestration from the atmosphere. Furthermore, CO₂ contained in flue gas emitted from a point source, may be contacted by a solution or pulp containing magnesium hydroxide dissolved and/or undissolved in water, respectively to remove most or all of the CO₂ from the waste stream. Other uses of the produced magnesium hydroxide include, but are not limited to, chemical reagent, buffering agent, pharmaceuticals, and source of magnesium oxide or magnesium metal.

According to one aspect of the invention, there is provided a method for producing a low-CO₂-emissions metal hydroxide and byproducts, comprising:
(a) leaching a mineral rock mass, using an acid, allowing for the extraction of one or more metals, thereby forming a leachate containing one or more dissolved metal salts;
(b) separating at least some of the one or more metals from the leachate using a neutralizing agent and oxygen gas;
(c) using a metal salt from the leachate from the step (b) as an electrolyte in an electrolysis cell to produce the oxygen gas, the acid and a metal hydroxide;
(d) supplying the acid produced in the electrolysis cell back to the leaching step (a); and
(e) supplying the oxygen gas produced in the electrolysis cell back to the separating step (b); thereby producing the metal hydroxide and byproducts, the byproducts being the at least some of said one or more metals, the metal salt, the oxygen gas, and the acid.

The method further comprises using the metal hydroxide produced in the step (c) for removing and sequestering carbon dioxide.

In the method described above, the mineral or rock mass contains at least some metal silicate, said metal being a member of the Group 1 or Group 2 elements of the periodic table.

In the method described above, the metal silicate is predominantly magnesium silicate.

In the method described above, wherein the mineral or rock mass contain at least one metal other than magnesium, and wherein at least some of the one or more metals are soluble and extractable from the rock mass in the presence of the acid.

In the method described above, the rock mass contains asbestos fibers, the method further comprising at least reducing a quantity of the asbestos down to a predetermined asbestos level via reaction with the acid.

In the method described above, the rock mass contains a fibrous composition, the further method comprising at least reducing a quantity of the fibrous composition down to a predetermined fiber level via reaction with the acid.

In the method described above, the rock mass is composed of naturally-occurring or produced rock fragments such as mine tailings that are massed in a heap or are contained in a vessel such as a vat.

In the method described above, the rock fragments are irrigated with or immersed in the acid, preferably a 2% to 20% concentrated sulfuric acid solution and more preferably a 4% to 12% concentrated sulfuric acid solution such that at least some of the metals contained in the rock mass are leached from the rock mass and converted to dissolved metal salts, preferably dissolved metal sulfates.

In the method described above, the step (b) comprises adding the metal hydroxide such that a saturation state of at least some of the one or more metals in the leachate is exceeded, thereby precipitating of said at least some of the one or more metals from solution as solid metal hydroxide.

In the method described above, the precipitating the one or more metals includes precipitating nickel, cobalt, iron, chromium, and excludes precipitating magnesium and calcium.

In the method described above, a metal in the metal hydroxide being added in the step (b) is a member of Group 1 or Group 2 elements of the periodic table, preferably calcium or magnesium.

In the method described above, the adding the metal hydroxide comprises adding metal hydroxide is sufficient to elevate a pH of the leachate to about 3.8-4.9, and preferably to about 4.4-4.8, for precipitating iron from the leachate as iron hydroxide, followed by further adding the metal hydroxide sufficient to elevate the pH of the leachate to about 8-9.5, and preferably to about 8.5-9.3 for precipitating nickel and cobalt from the leachate as nickel and cobalt hydroxide.

In the method described above, the electrolysis cell has an anode and a cathode at least partially submerged in an electrolyte solution containing the metal salt, the method further comprising applying across the anode and cathode a direct electric current having a voltage in a range from about 2 V to about 25 V, and preferably 5 to 20 V, and a current density in a range from about 150 A/m² to about 9000 A/m², and preferably from about 3000 A/m² to about 7000 A/m².

In the method described above, the metal salt is a member of the Group 1 or Group 2 elements of the periodic table, preferably magnesium sulfate at magnesium concentration from about 40 g/L Mg to about 100 g/L, Mg and yet preferably 60 g/L Mg to 80 g/L Mg.

In the method described above, the acid is sulfuric acid.

In the method described above, the metal hydroxide is one or more of magnesium hydroxide and calcium hydroxide.

The method further comprises introducing a separator, or separating medium, such as a diaphragm or a membrane between the anodic and cathodic compartments, The separating medium can be semi permeable to ions and water, and display a permeability ranging from about 0.1 to about 17 NLdm⁻²min⁻¹, and preferably from about 1 dm⁻²min⁻¹ to 6NL dm⁻²min⁻¹.

The method further comprises filling the anode compartment with an acidic electrolyte solution and filling the cathode compartment with the electrolyte solution such that only very limited amount from the electrolytes solution migrates through said membrane or diaphragm by preferably maintaining the electrolyte solution level in the cathode compartment at a higher level than the electrolyte solution level in the anode compartment.

The method further comprises contacting and reacting said metal hydroxide with CO₂ as contained in air or a waste gas stream to remove and sequester said CO₂ from said air or said waste gas stream.

The method further comprises converting the sequestered CO₂ to a solid magnesium or calcium carbonate, a dissolved magnesium or calcium carbonate, or dissolved magnesium or calcium bicarbonate, and storing them under the ground or in a large body of water such as a pond, lake, reservoir, river, or ocean.

The method further comprises adding said metal hydroxide to a large body of water such as a pond, lake, reservoir, river, or ocean so as to facilitate said contacting and reacting with CO₂ as contained in air.

In the method described above, the metal hydroxide may be placed in water as contained in a vessel, followed by purging or bubbling air or a waste gas stream containing CO₂ through the solution containing metal hydroxide, to reduce the CO₂ burden of said air or water gas stream.

In the method described above, at least some or all of the energy used in the method is derived from low- or non-CO₂-emitting sources that can include but are not limited to wind, solar, nuclear and hydro sources of energy generation.

According to another aspect of the invention, there is provided a system for producing a metal hydroxide and byproducts, the system comprising:
(a) a leaching unit for leaching, using an acid, a mineral rock mass containing one or more metals, thereby forming a leachate containing dissolved metal salts;
(b) a processing unit for separating at least some of the one or more metals from the leachate using oxygen gas;
(c) an electrolysis cell, using a metal salt from the leachate from the step (b) as an electrolyte and producing the oxygen gas, the acid and a metal hydroxide;
(d) a first feedback, supplying the acid produced in the electrolysis cell back to the leaching step (a); and
(e) a second feedback, supplying the oxygen gas produced in the electrolysis cell back to the processing unit (b);
thereby producing the metal hydroxide and byproducts, the byproducts being the at least some of said one or more metals, the metal salt, the oxygen gas, and the acid.

The system further comprises a carbon capture and sequestration unit using the metal hydroxide produced in the electrolysis cell (c) for removing and sequestering carbon dioxide.

In the system described above, the rock mass is in a form of a pile or heap, or is contained in a vessel or vat allowing an acid solution containing the acid to pass through and contact with said rock mass.

In the system described above, the acid is sulfuric acid, preferably in a concentration of about 4% to about 12% by weight.

In the system described above, the rock mass contains more than 20% magnesium by weight.

In the system described above, the acid solution, upon passing through and contacting said rock mass, contains dissolved metal salts including magnesium salts, the system further comprising means for adding the metal hydroxide to the acid solution to elevate a pH of the acid solution to precipitate metals other than dissolved metal salt, said other metals containing nickel, cobalt, iron, aluminum and chromium.

In the system described above, the means for adding comprises means for adding calcium hydroxide or magnesium hydroxide, preferably an about 20% by weight solution of the calcium hydroxide.

In the system described above, the electrolysis cell comprises an anode and a cathode at least partially immersed in an electrolyte solution containing dissolved magnesium salt, a direct electric current voltage is applied across the cathode and the anode, thereby producing the hydrogen gas and the magnesium hydroxide on or near the cathode, and the acid and the oxygen gas at or near the anode.

In the system described above, the magnesium salt is magnesium sulfate in a concentration of about 40-80 g/L Mg, said voltage is ranges from 5 to 20 V, said anode is catalytically coated titanium, and said cathode is stainless steel.

In the system described above, the acid is sulfuric acid, the metal hydroxide is magnesium hydroxide; the system further comprising means for capturing and sequestering carbon dioxide.

In the system described above, at least some or all of the energy used in said system is derived from low- or non-CO₂-emitting sources that can include but are not limited to wind, solar, nuclear and hydro sources of energy generation.

Thus, an improved method and system for magnesium hydroxide and byproducts generation from mineral resources, and application of the magnesium hydroxide for sequestering carbon dioxide, have been provided.

### BRIEF DESCRIPTION OF THE DRAWINGS

The accompanying drawings, which constitute a part of the specification, illustrate specific embodiments of the invention which, together with the detailed description of the specific embodiments, serve to explain the principles of the invention.

FIG. 1 shows a schematic representation of functional steps/blocks for mass production of magnesium hydroxide and various byproducts from mineral resources according to the embodiments of the invention;

FIG. 2 illustrates inputs and outputs of the Leaching Circuit of FIG. 1 in more detail;

FIG. 3 illustrates a two-stage counter-current implementation of the Leaching Circuit of FIG. 2;

FIG. 4 illustrates an experimental setup 140 for testing a heap leach column of the leaching stage 100 of FIG. 1;

FIG. 5 illustrates an experimental setup 150 for testing a vat leach column of the leaching stage 100 of FIG. 1;

FIG. 6 illustrates an operation of the Impurity Removal Circuit 200 of FIG. 1 in more detail;

FIG. 7 shows an experimental setup of the Electrolysis Circuit 300 of FIG. 1;

FIG. 8 illustrates one implementation 302a of the electrolysis cell 302 of FIGS. 1 and 7;

FIG. 9 illustrates another implementation 302b of the electrolysis cell 302 of FIGS. 1 and 7;

FIG. 10 shows an experimental apparatus 1000 for investigating CO₂ capture in batch-mode from a CO₂-rich gas stream using magnesium hydroxide pulp produced by the system of FIG. 1;

FIG. 11 shows an experimental setup for continuous CO₂ capture and storage system via magnesium hydroxide pulp carbonation;

FIG. 12 illustrates a two-stage counter-current carbon dioxide removal industrial scrubbing system; and

FIG. 13 schematically illustrates ocean alkalinity enhancement, applied to surface ocean waters in contact with the atmosphere.

### DETAILED DESCRIPTION OF THE EMBODIMENTS

Embodiments of the present invention describe production of magnesium hydroxide from ores, waste rocks, and tailings rich in magnesium. Further, the magnesium hydroxide is used for CO₂ capture and permanent sequestration, although it is understood that the produced magnesium hydroxide may be also used for other purposes.

Embodiments also describe production of other electrochemical and metallurgical byproducts such as a hydrogen, oxygen, sulfuric acid, as well as various mixed-hydroxide products carrying significant economic and CO₂-capture values.

Additionally, the embodiments of the invention describe the remediation of asbestos containing tailings by rendering thereof asbestos-depleted as a result of reaction with sulfuric acid.

Also, the embodiments of the invention describe production of magnesium-sulfate-containing solution from depleted mineral resources rich in magnesium, comprising leaching the depleted mineral resource with the dilute acid stream generated from the electrolysis cell.

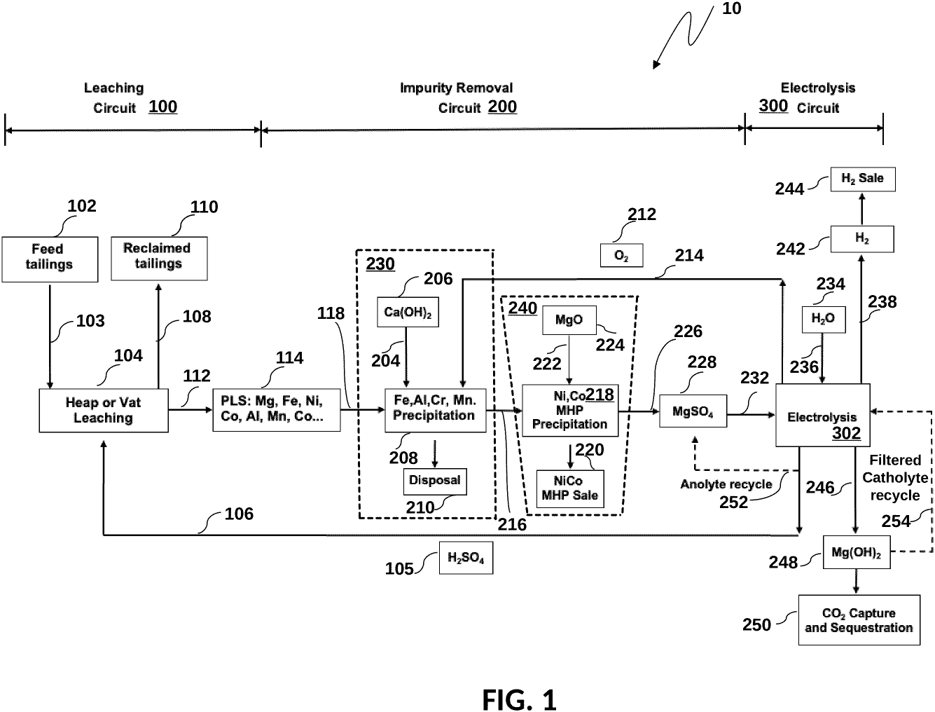

FIG. 1 illustrates a system 10 for production of magnesium hydroxide and various byproducts from mineral resources according to the embodiments of the invention, for example production of magnesium hydroxide from a mineral rock mass containing magnesium silicates. For a cost efficient mass production, it may be beneficial to use the mineral rock mass containing at least 15%-20% magnesium by weight. However, it is understood that another magnesium content may be also suitable.

The system 10 comprises a Leaching Circuit 100, Impurity Removal Circuit 200, and Electrolysis Circuit 300.

In the Leaching Circuit 100, feed tailings 102 are supplied (arrow 103) and leached by heap or vat leaching or a combination thereof in the heap or vat leaching stage 104 using sulfuric acid produced in an electrolysis cell 302 of the Electrolysis Circuit 300, the sulfuric acid 105 being supplied (arrow 106) to the heap or vat leaching stage 104. The heap or vat leaching stage 104 outputs (arrow 108) reclaimed tailings 110 and also outputs (arrow 112) a Pregnant Leach Solution (PLS) or leachate 114 containing various metals, for example, Mg, Fe, Ni, Co, Al, Mn among others, to be recovered in the Impurity Removal Circuit 200. The reclaimed tailings 110 produced according to the embodiments of this description are free of physically or chemically harmful materials that were contained in the minerals and rock mass 102 used as feed to the process.

The Impurity Removal Circuit 200 comprises Iron and Other impurities removal circuit 230, and nickel and cobalt removal circuit 240, to be also referred to as Mixed Hydroxide Precipitation 240 circuit. In the circuit 230, removal of iron and other impurities, for example Al, Cr, Mn, is performed by precipitation, upon supplying (arrow 118) the PLS, supplying (arrow 204) a metal hydroxide solution or slurry 206 to a first reaction vessel 208, and reacting the PLS and the metal hydroxide, followed by precipitation and disposal 210 of iron and other impurities. The metal in the metal hydroxide solution or slurry 206 is derived from the Group 1 or Group 2 elements of the periodic table, preferably calcium or magnesium. Also preferably, the reaction in the first reaction vessel 208 is performed in the presence of oxygen 212 produced in the Electrolysis cell 302 and supplied (arrow 214) to the first reaction vessel 208. Next, the remaining solution from the first reaction vessel 208 is supplied (arrow 216) to a second reaction vessel 218 of the nickel and cobalt removal stage 240, where nickel, cobalt and other valuable metals are precipitated in the form of a mixed hydroxide product 220, the reaction in the second reaction container 218 being conducted with additionally supplied (arrow 222) magnesium oxide 224.

The second reaction vessel 218 outputs (arrow 226) magnesium sulfate solution 228, which is further supplied (arrow 232) as electrolyte to the Electrolysis cell 302 of the Electrolysis Circuit 300. The Electrolysis cell 302 consumes (arrow 232) magnesium sulfate solution 228 as electrolyte, consumes (arrow 236) water 234, and performs an electrolysis process, outputting (arrow 106) sulfuric acid 105 produced at anode, outputting (arrow 214) oxygen 212 produced at anode, outputting (arrow 238) hydrogen 242 produced at cathode, for example to be sold as a separate product 244, and also outputting (arrow 246) magnesium hydroxide 248 produced at cathode, which is further used for carbon dioxide capture and sequestration 250.

Anolyte produced at the anode of the electrolysis cell 302 is partly recycled back (arrow 252) to the electrolysis cell 302, whilst a certain amount is withdrawn and directed to the leaching circuit. (arrow 106). Also catholyte solution is filtered to separate the magnesium hydroxide 248 followed by recirculation (arrow 254) back to the electrolysis cell 302 to complete the electrochemical reaction, while being continuously replenished with free magnesium sulphate catholyte feed.

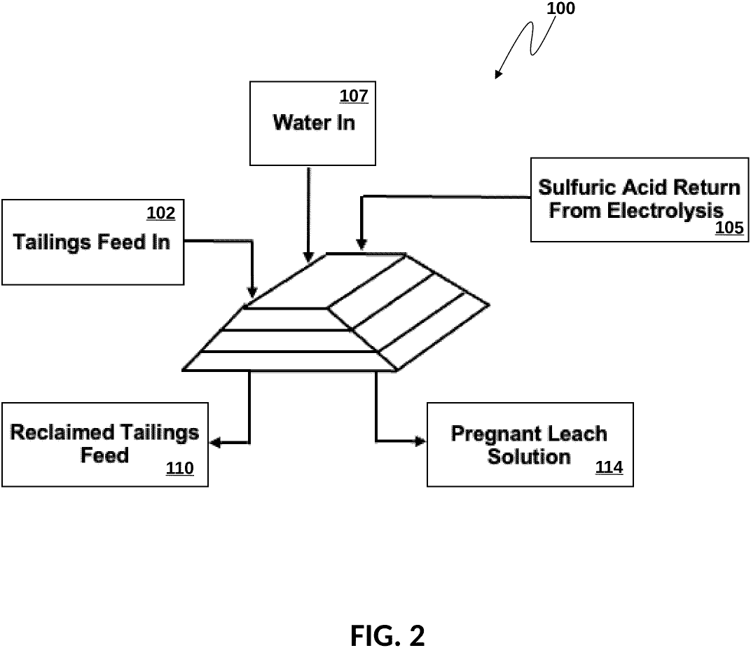

FIG. 2 illustrates inputs and outputs of the Leaching Circuit 100 of FIG. 1 in more detail, which are applicable to both heap or vat leaching. The tailings 102 are stacked in a heap 109 or loaded into a reaction vessel in vat (not shown in FIG. 2), and exposed to lixiviant containing a diluted sulfuric acid solution containing sulfuric acid 105 produced in the electrolysis cell 302 mixed with additionally supplied water 107, thereby outputting reclaimed tailings 110 and PLS 114.

In the heap leaching implementation of the Leaching Circuit 100, the tailings 102 are stacked in a heap and then irrigated from the top with lixiviant containing a diluted sulphuric acid 105 produced by the Electrolysis Circuit 300. The resulting pregnant leach solution 114 is collected from the bottom and directed to the Impurity Removal Circuit 200, as mentioned above. The leached heap residue consists of a reclaimed material, and it is left in place as such.

In the vat leaching stage implementation of the Leaching Circuit 100, the tailings 102 are loaded into large reaction vessels (not shown) into which the lixiviant 105 is pumped into the bottom and recycled from the top. The resulting pregnant leach solution 114 is collected from the top and directed to the Impurity Removal Circuit 200 similarly to the above noted heap leaching implementation. The leached vat residue consists of a reclaimed material, and it is discharged from the vat then disposed at the bottom of the next heap leach pad, above a geotextile membrane.

Heap and vat leach operations can preferentially conducted in parallel configurations provided the downstream Impurity Removal Circuit 200 is sized appropriately to the irrigation flowrates of the Leaching Circuit 100. Such operational redundancy may become useful for winter-months when the kinetics of the heap leach may suffer due to the lower temperatures.

According to one embodiment of the invention, applied for an asbestos tailings sample, heap leaching has been conducted at ambient temperature at irrigation flowrates ranging from about 0.1 to about 1.0 L/min.m², and preferably from about 0.2 to about 0.6 L/min.m². The duration of the heap leaching ranged from about 30 days to about 280 days, preferably from about 60 days to about 120 days, depending on the required leaching extraction efficiency and downstream processing efficiency.

The stoichiometry molar requirement of the equivalent pure acid versus complete magnesium leaching ranged from about 0.3 to about 1.8, and preferably from about 0.7 to about 1.3 as a function of the leaching extraction efficiencies for all metals contained in the feed 102.

The concentration of sulfuric acid 105 ranged from about 1% wt. to about 30% wt., and preferably from about 4% wt. to about 15% wt. Process parameters for the leaching process are determined by various factors including but not limited to mineral feed grade, composition, mineralogy, crush-size etc.

The process parameters are tailored to meet the above-mentioned feed-specific characteristics, noting that they can vary widely from one deposit to other, or even within the same deposit. As a result, ranges for defining parameters including lixiviant concentration, irrigation rate and duration of leaching may be set within ranges described in Examples described below.

In addition, the process parameters ranges may be further optimized to allow for increased heap height without affecting its stability, thereby maximizing economically viable extractions. These process parameter ranges need to consider that heap stability decreases with the increase of irrigation rate at a certain crush-size.

According to another embodiment, leaching was conducted in vat configuration. Vat leaching was conducted at ambient temperature at irrigation flowrates ranging from about 0.3 to about 2.4 L/min.m², and preferably from about 0.4 to about 1.5 L/min.m². The duration of the vat leaching ranged from about 15 days to about 70 days, and preferably from about 30 days to about 55 days, also depending on the metallurgical response of the ore feed, or the maximum achievable extraction efficiency. The stoichiometry molar requirement of the equivalent pure acid versus complete magnesium leaching has ranged from about 0.3 to about 1.2, preferably ranging from about 0.7 to about 1.1 as a function of the maximum extraction efficiencies for all metals contained in the feed. The concentration of sulfuric acid has ranged from about 1% wt. to about 30% wt., preferably ranging from about 4% wt. to about 15% wt.

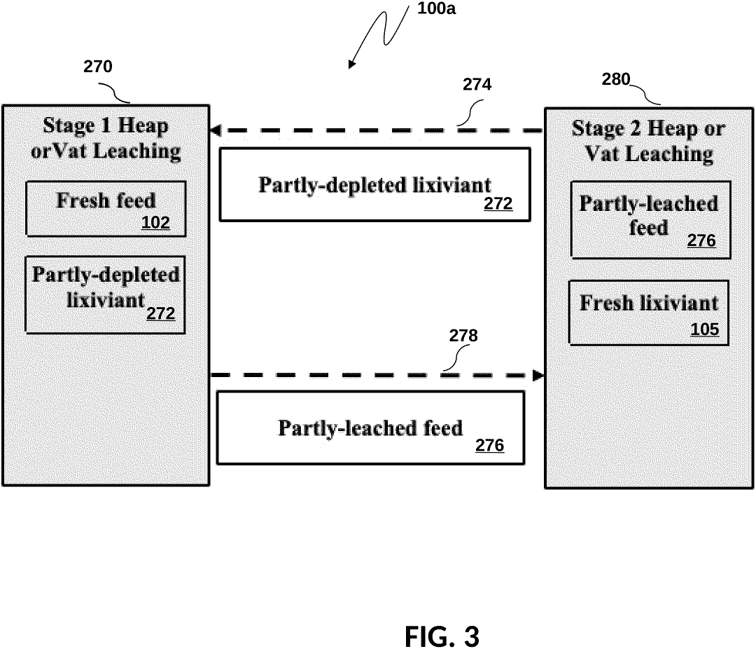

According to yet another embodiment, heap and vat leaching were conducted in two counter-current stages as illustrated in FIG. 3. In more detail, FIG. 3 illustrates a Leaching Circuit 100a having a first leaching stage 270 and a second leaching stage 280 arranged in a counter-current configuration.

In the first leaching stage 270, the leaching is conducted by heap or vat leaching using the fresh feed 102 and semi-spend (partially depleted) lixiviant containing a partially depleted acid solution 272 supplied (arrow 274) from the second leaching stage 280.

In the second leaching stage 280, the leaching is conducted by heap or vat leaching sing a partially leached feed 276 from the first leaching stage 270 (“inter-stage” reside) supplied (arrow 278) to the second leaching stage 280, and a fresh lixiviant 105 supplied from the Electrolysis cell 302.

The duration of each counter-current stage, the first leaching stage 270 and the second leaching stage 280, is determined by the reaction kinetics which, in turn, defines the maximum practical extractions for a certain feed processed under the optimized leaching parameters for that material. For example, a shorter duration vat leaching aiming for over 80% magnesium extraction may need about 7 to 10 days to consume the excess of acidity contained in the partly depleted lixiviant 272 during stage 1 (270), while producing about 25-30% extraction from the fresh feed (102). Of note, the partly depleted lixiviant 272 becomes an enriched pregnant leach solution during this stage 1, while the feed becomes partly-leached. The subsequent second leaching stage (280) is conducted with fresh lixivant 105 contacting the partly-leached feed 276 and allowed to continue for 2-3 weeks until the overall extraction reaches the target 80% in this example.

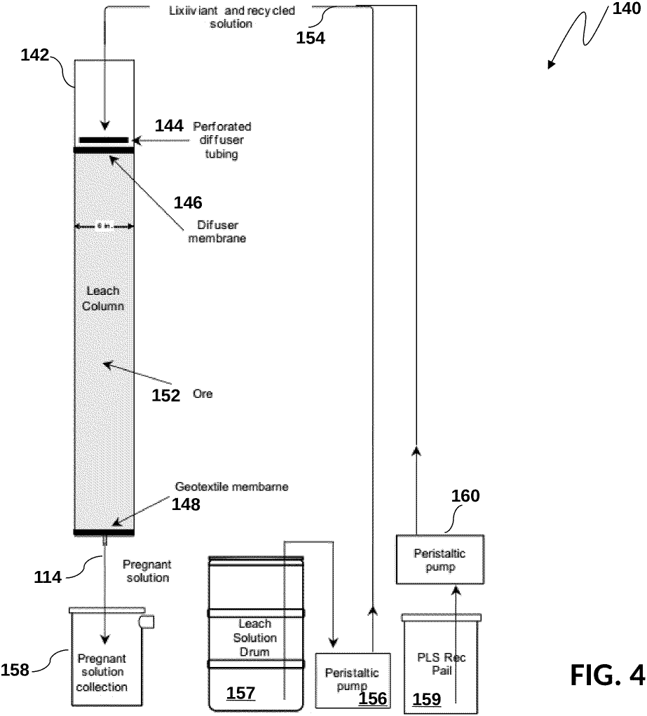

FIG. 4 illustrates an experimental setup/apparatus 140 for testing a heap leach column of the leaching stage 100 of FIG. 1, or the first leaching stage 270 and/or the second leaching stage 280 of FIG. 3 when the first leaching stage 270 and/or the second leaching stage 280 use heap leaching.

The apparatus 140 includes a leach column 142 provided with a perforated-diffuser tubing 144 at the top, a diffuser membrane 146 beneath the perforated-diffuser tubing 144, and a perforated bottom fitted with a geotextile membrane (cloth) 148 to retain the fines. The sample test-charge (ore) 152 is loaded into the leach column 142, covered with the diffuser membrane 146. The sample ore 152 loaded into the leach column 142 is continuously irrigated with the lixiviant 154 pumped by a peristaltic pump 156 from its dedicated storage-drum 157, for a duration defined according to the present disclosure. The lixiviant 154 is recycled from PLS recycle pail 159 using another peristaltic pump 160 until it reaches certain pre-set parameters, for example, as disclosed in the Examples below. At this point it becomes “Pregnant Leach Solution” (PLS) 114, and it is collected continuously in a separate storage vessel 159.

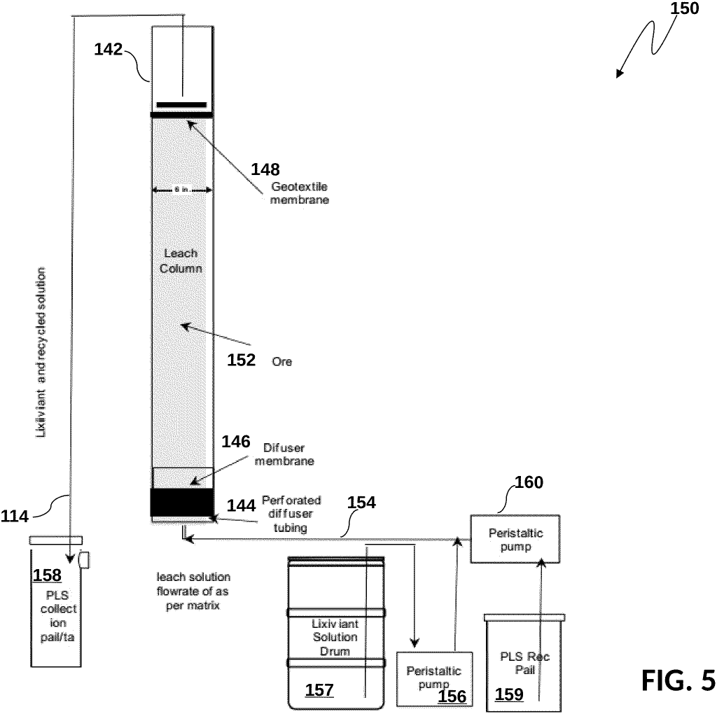

FIG. 5 illustrates an alternative experimental setup/apparatus 150 for testing a vat leach column of the leaching stage 100 of FIG. 1, or the first leaching stage 270 and/or the second leaching stage 280 of FIG. 3 when the first leaching stage 270 and/or the second leaching stage 280 use vat leaching.

The apparatus 150 includes a leach column 142 provided with a diffuser membrane material 146 and perforated diffuser tubing 144 at the bottom which allows flow of the lixiviant 154 through while preventing solids to pass. The lixiviant 154 is pumped by the peristaltic pump 156 into the bottom of the leach column 142 from the lixiviant solution drum 157. The lixiviant 154 percolates through the ore 152, and it is discharged from the top of the leach column 142 through the geotextile membrane 148, and recycled (arrow 153) until it reaches certain pre-set parameters, for example as disclosed in the Examples below. Analogous to the heap-leaching arrangement of FIG. 4, at this point the lixiviant becomes a “Pregnant Leach Solution” (PLS) 114, and it is collected continuously in a separate storage vessel 158. Similar to FIG. 4, the lixiviant 154 is recycled from PLS recycle pail 159 using the another peristaltic pump 160.

As mentioned above, the Impurity Removal Circuit 200 comprises Iron and Other impurities removal circuit 230, and nickel and cobalt removal circuit 240, also referred to as Mixed Hydroxide Precipitation 240 circuit.

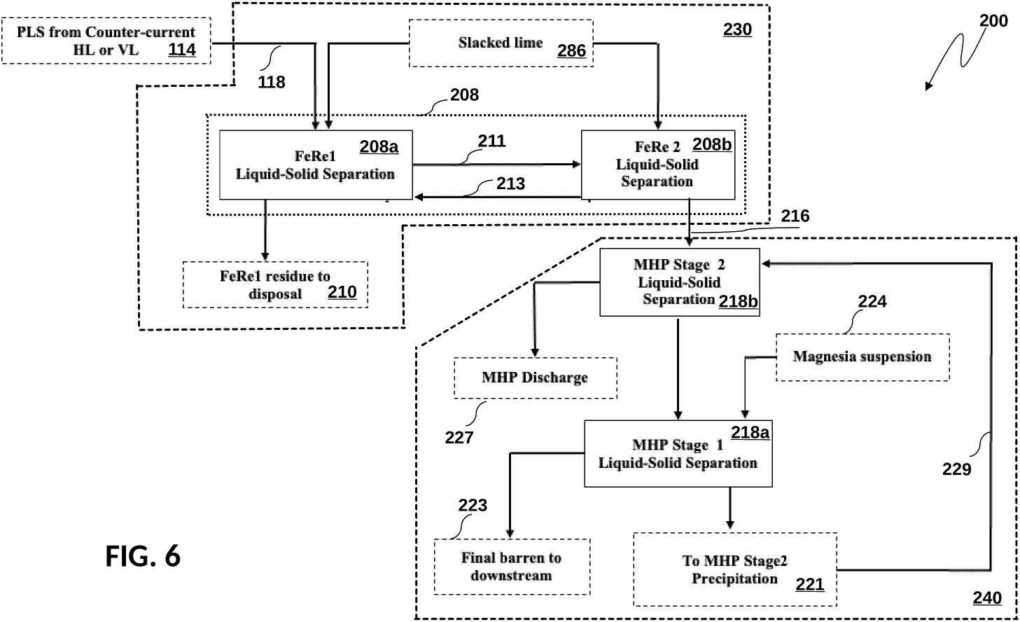

FIG. 6 illustrates the operation of the Impurity Removal Circuit 200 of FIG. 1 in more detail, including dual counter-current stages for the Iron and other impurities removal circuit 230 and Nickel and Cobalt removal circuit 240.

In the Iron and Other Impurities Removal Circuit 230, the pregnant leach solution 114 from the Leaching Circuit 100 is subjected to the precipitation of iron and accompanying impurities such as aluminum, manganese, chromium and others 208 by oxidation with the oxygen 212 and in the presence of slaked lime or slaked magnesia as neutralizing agent (box 286). The precipitation of iron and other impurities 208 is performed in two stages 208a and 208b, as will be described in more detail below.

The resulting precipitate containing metal hydroxides and gypsum is dispersed in order to exploit its carbon capture potential. Once the metal hydroxides are carbonated, the material is sealed by covering it with the impermeable membrane used to build the next operating heap leach pad.

The removal of iron and accompanying impurities is realized by injecting oxygen 212 at a volume flow rate ranging from about 0.01 to about 1.2 vvm (volume/volume.minute) versus the slurry phase and preferably from about 0.1 to about 0.5 vvm. The pH is maintained within the about 2.1 to about 4.9-range, and preferably from about 2.5 to about 3.5 by the addition of a metal hydroxide solution or slurry, the metal being derived from Group 1 or Group 2 elements of the periodic table, preferably calcium or magnesium. The oxidation-potential is maintained within about 150-350 mV versus the silver/silver chloride reference, and preferably from about 250 to about 300 mV. The process temperature ranges from about 15° C. to about 95° C. and preferably from about 25 to about 80° C. The residence time ranges from about 1 hour to about 4 hours, and preferably from about 1 hour to 3 about hours.

The process of iron and impurities removal 208 can be run preferentially in two stages 208a and 208b. The solid material formed at pH of about 3.0-3.5 during the first stage precipitate 208a is separated from the first stage barren solution by thickening and subsequent filtration of the resulting underflow. The resulting residue filter-cake is directed to disposal 210. The resulting first-stage barren solution containing a mix of thickener overflow and filtrate is directed 211 to the second stage iron and impurities removal 208b.

The second stage 208b of iron and impurities removal 208 is realized under similar operating conditions as the first stage 208a, except for the pH which ranges from about 3.0 to about 4.9, and preferably from about 3.9 to about 4.4 The solid precipitate formed in the second stage 208b is separated from the barren solution in a manner similar to the first stage. The necessity of filtration however is determined by the actual amount of equivalent dry solids contained in the underflow. The resulting underflow or filter cake is directed to the first-stage iron and impurities removal 213.

The dual-stage efficiency determines the overall exit condition for the above noted processing steps of the iron and other impurities removal circuit 230, or when at least 90% of the targeted impurity metals have been removed from the pregnant leach solution 114.

Valuable metals such as nickel, cobalt, and others, when present are precipitated in the second reaction container 218 of the Nickel Cobalt Removal Circuit 240 from the barren solution 216 emerging from the Iron and other Impurities Removal Circuit 230 in the form of a mixed hydroxide product. The product is a valuable intermediate feedstock for the production of batteries among other uses. The precipitation of nickel and cobalt is realized at ambient temperature by dosing a magnesium hydroxide slurry.

Nickel and cobalt precipitation 218 is performed in two stages.

In the first stage 218a, mixed hydroxide product precipitation is conducted using second stage precipitation 218b as feed 217, in the presence of magnesia suspension 224.

The molar stoichiometry excess addition versus the sum of nickel and cobalt ranges from about 1 to about 2 and preferably from about 1.2 to about 1.8. The pH of the hydroxide slurry is maintained within a range from about 8 to about 9.5, and preferably from about 8.5 to about 9.3. The residence time ranges from about 0.5 hour to about 2.5 hours, and preferably from about 1 hour to about 2 hours. Metal hydroxides other than calcium or magnesium hydroxide may also be used.

The solid material formed during the first stage precipitation 218a is separated from the first-stage barren solution 223 by thickening and subsequent filtration of the resulting underflow. The resulting residue filter-cake 221 is directed (arrow 229) to the second stage precipitation 218b. The resulting first stage barren 223 containing a mix of thickener overflow and filtrate is directed to downstream processing.

The second stage 218b mixed hydroxide product precipitation is conducted using the iron removal discharge barren-solution 216 as feed and the second stage precipitate 221 as main reagent supplied (arrow 223) back to the second stage 218b. The pH is maintained within about the same range as for the first-stage precipitation 218a using the same reagent. The solid material formed during the second stage precipitation 218b is separated from the second-stage barren solution by thickening and subsequent filtration of the resulting underflow (box 227). The resulting residue filter-cake is directed to drying and conditioning of the product for the market. The resulting first stage barren 217 containing a mix of thickener overflow and filtrate is directed to the first stage precipitation 218a.

Similar to the Iron and Other impurity removal circuit 230, the above pH and residence time conditions used in the Nickel and Cobalt Removal circuit 240 have been optimized to maximize the removal of desired metals from the solution. The exiting condition for the circuit 240 is when at least 80% of nickel and cobalt have been recovered.

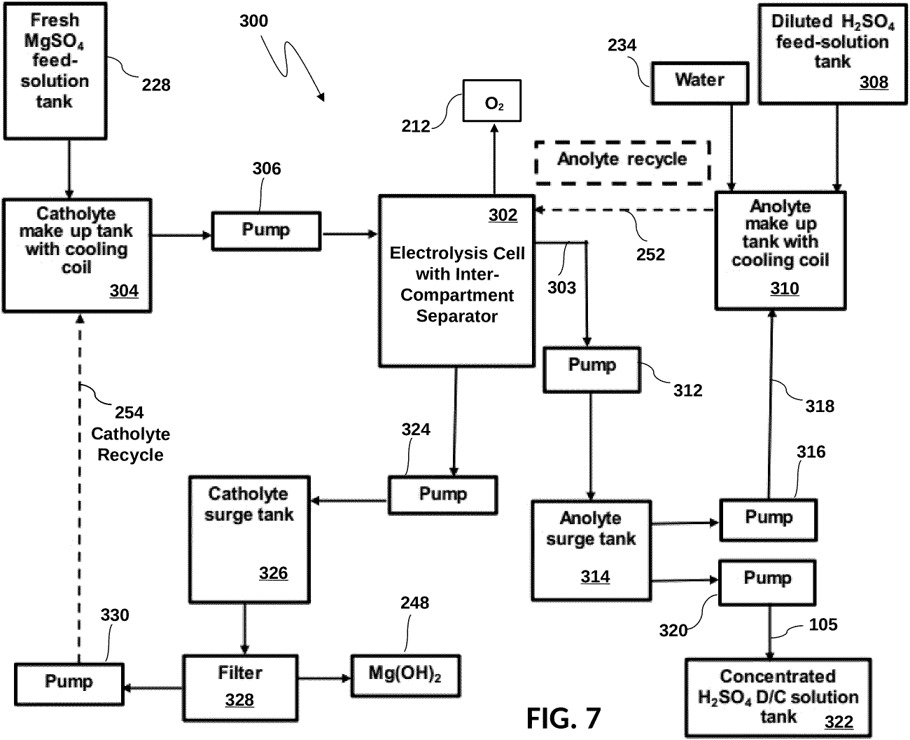

FIG. 7 shows an experimental setup of the Electrolysis Circuit 300 for the electrochemical production of the magnesium hydroxide concomitant with the regeneration of the diluted sulfuric acid to be used for the Leaching Circuit 100.

For the operation of the Electrolysis cell 302, magnesium hydroxide from MgSO₄ feed-solution tank 228 is supplied to the catholyte make up tank 304 with cooling coil, followed by pumping the catholyte to the Electrolysis cell 302 by pump 306. Also a diluted sulfuric acid from a H₂SO₄ feed-solution tank 308 is supplied to an anolyte make up tank 310 along with water 234 to produce and supply 252 as fresh anolyte to the Electrolysis cell 302.

At the same time, the anolyte 303 produced at the anode is pumped out the Electrolysis cell 302 by pump 312 into an anolyte surge tank 314, followed by pumping the anolyte from the anolyte surge tank 314 back to the anolyte make up tank 310 (pump 316, arrow 318) as required to maintain a predetermined level and concentration of the anolyte in the Electrolysis cell 302, thereby recycling the anolyte (boxes 312, 314, 316, 310 and arrow 252) back to the Electrolysis cell 302. Also, oxygen 212 is produced at the anode of the Electrolysis cell 302.

Also, the anolyte from the anolyte surge tank 314 is pumped out by another pump 320 for further preparation of the concentrated sulfuric acid (not shown), followed by storing the concentrated sulfuric acid in a concentrated H₂SO₄ solution tank 322. As mentioned above with regard to FIG. 1, some of the anolyte is recycled internally withing the electrolysis cell 302, and some is withdrawn and directed to the Leaching Circuit 100 for heap or vat leaching. Catholyte from the electrolysis cell 302 is pumped out by pump 324 and stored in a catholyte surge tank 326, followed by filtering (filter 328) a solid magnesium hydroxide 248, and pumping, by pump 330, the remaining catholyte back to the catholyte make up tank 304, thereby recycling (arrow 254) the catholyte.

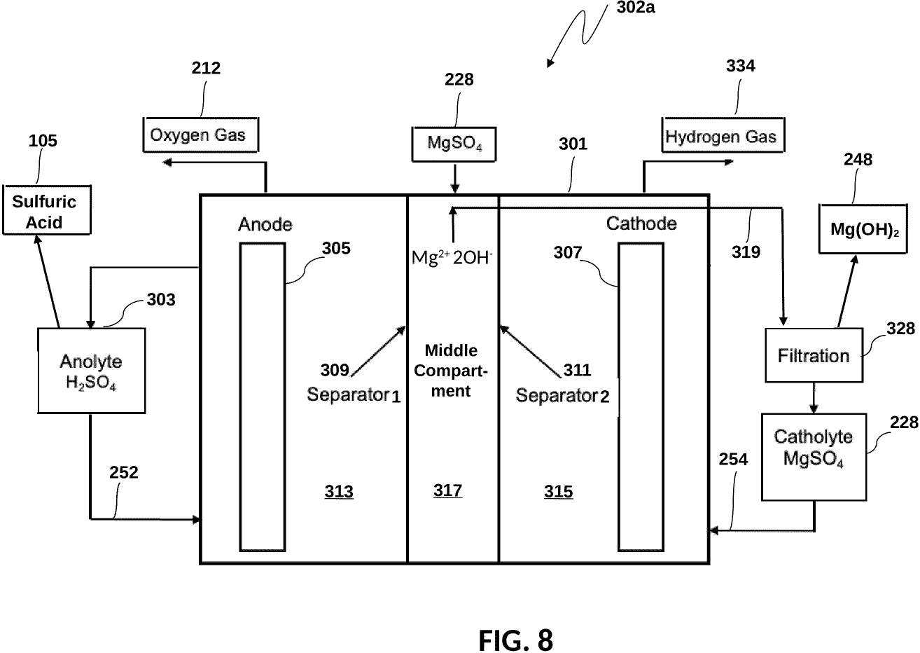

FIG. 8 illustrates an Electrolysis cell 302a, which is one implementation of the Electrolysis cell 302 of FIGS. 1 and 7.

In the Electrolysis cell 302a, an electrolytic container 301 has an anode 305 and a cathode 307, both electrodes connected to a source of direct current (now shown). The electrolytic container 301 has a first, cation exchange separator 309, and a second, anion exchange separator 311 to create a 3-chambered electrolytic container 10, dividing the electrolytic container 301 into anode region (anolyte chamber) 313, a cathode region 315 and a central region (or middle compartment) 317.

The electrolytic container 301 is filled at least partially with magnesium sulfate (MgSO₄), dissolved in water 228, such that when the direct current (DC) is applied to the anode 305 and the cathode 307, hydrogen gas (H₂) and hydroxide ions (OH⁻) are generated at the cathode 307, and oxygen (O₂) gas and hydrogen ions (H⁺) at the anode 305. The OH⁻ ions are then charge-balanced by Mg²⁺ (from the metal salt) forming a metal hydroxide, and the H⁺ ions are balanced by the SO₄²⁻ ions (from the metal salt) forming sulfuric acid, H₂SO₄ 105 that is separated from the anolyte 303. As required the anolyte 303 is recycled (arrow 252) back to the electrolytic container 301.

Some of the catholyte solution 319 now containing magnesium hydroxide is withdrawn from the middle compartment 317 into a filtration unit 328 for separating solid magnesium hydroxide 248 from the remaining catholyte solution 228, the latter to be recycled back to the electrolysis cell 302a (arrow 254).

Due to the 3-compartment design of the electrolysis cell 302a, the metal cations Mg²⁻from the metal salt electrolyte and OH⁻ produced at the cathode 307 combine to form a magnesium hydroxide in the central region 317. This prevents the formation of metal hydroxide from occurring in close proximity to the cathode 307 where the precipitation of the metal hydroxide may occur and thus degrade the operation of the electrolysis cell 302a.

Also the cathode compartment 315 is filled in with the electrolyte solution such that the electrolyte solution also migrates through said separators 311 and 309 to also fill said anode chamber 313, and preferably maintaining the electrolyte solution level in the cathode chamber at a higher level than the electrolyte solution level in the anode chamber. This configuration allows for smooth operation of the electrolysis cell 302, because it mitigates the hydrostatic effect arising due to the different densities of the electrolytes.

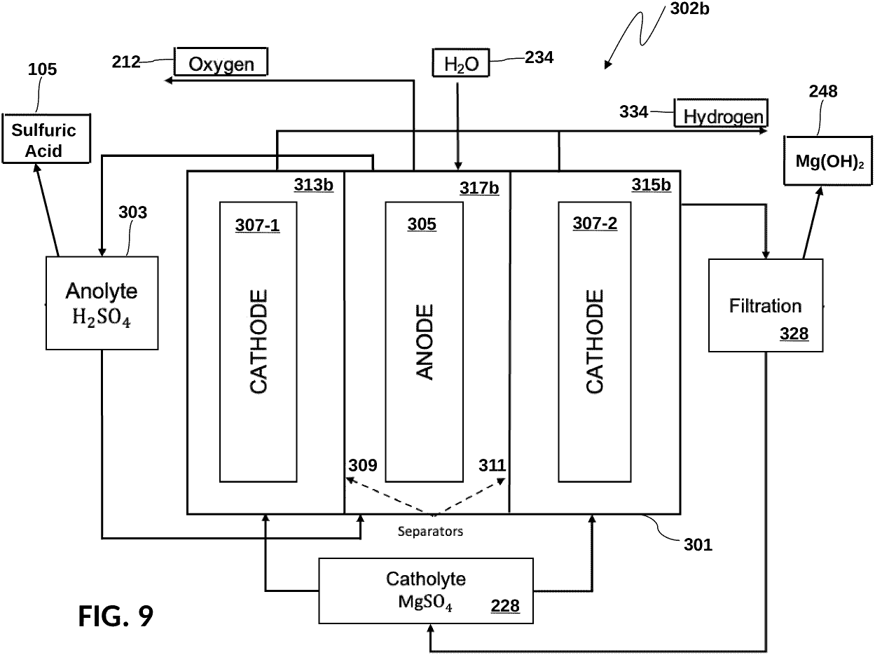

FIG. 9 illustrates an Electrolysis cell 302b, which is another implementation of the Electrolysis cell 302 of FIGS. 1 and 7.

The electrolysis cell 302b of FIG. 9 is similar to the electrolysis cell 302a of FIG. 8, except the electrolysis cell 302b now has two cathodes 307-1 and 307-2, and the anode 305 inbetween, thereby dividing the electrolytic container 301 into the two cathode compartments 313b and 315b, and anode compartment 317b.

Catholyte 228 is supplied to both cathode compartments 313b and 315b, hydrogen gas 334 is produced at both cathodes 307-1 and 307-2, and oxygen gas 212 is produced at the anode 305 as before.

Magnesium hydroxide is formed at both cathodes 307-1 and 307-2 (not shown in FIG. 9). The rest of the operation of the electrolysis cell 302b is similar to that of electrolysis cell 302a described above. Similar items in FIGS. 8 and 9 have been labeled with the same reference numerals.

In all implementations of the Electrolysis cell 302, the catholyte-slurry is circulated through a surge-tank 326 and a filtration unit 328 as shown in FIG. 7. The filtrate feeds the catholyte make-up tank 304 which is fitted with a temperature-control loop. The magnesium hydroxide filter cake-discharge discharge is collected as produced 248.

The fresh magnesium sulphate solution 228 is fed into the catholyte make-up tank 304. The feeding rate is set as a function of the magnesium retrieved as hydroxide. Similarly on the anolyte side, the diluted sulfuric acid-feed 308 and water-feed 234 are dosed based on the allowable bleed rate of the equivalent pure acid discharged 322 in the concentrated stream. The anolyte make-up tank 310 is temperature-controlled.

In more detail, the magnesium sulphate contained in the solution 228 emerging from the nickel and cobalt precipitation circuit 240 providing removal of those valuable metals from the mineral leachate is subjected to the electrolytic process in the Electrolysis Circuit 300 that regenerates the sulfuric acid 105 for leaching while producing magnesium hydroxide f248 or carbon capture. As mentioned above, the electrolysis produces oxygen 212 that is used in the metallurgical process as outlined herein. The hydrogen 334 (see FIGS. 8 and 9) may be used as a fuel source or as a chemical feed stock. Electrolysis may be conducted by separating the cathode and anode compartments using anionic, cationic or non-ionic-selective membranes (first and second separators 309 and 311). More advantageously, anionic membranes or non-ionic-selective diaphragms may be used.

In an embodiment of the invention, a diaphragm with permeability ranging from about 0.1 to about 17 NLdm⁻²min⁻¹ is used, and preferably from about 0.5 to about 6 NLdm⁻²min⁻¹. The catholyte contains from about 10 g/L Mg to about 100 g/L Mg, and preferably from about 30 g/L Mg to about 80 g/L Mg. The anolyte contains from about 10 120 g/L H₂SO₄ to about 120 g/L H₂SO₄, and preferably from about 60 g/L H₂SO₄ to 90 g/L H₂SO₄. The process temperature ranges from about 20° C. to about 90° C., and preferably from about 30° C. to about 80° C. Electrolysis may be conducted at applied current ranging from about 5 A to about 50 A, and preferably from about 15 A to about 35 A. Electrolysis may be conducted at a potential ranging from about 2 V to about 30 V, and preferably from about 5 V to about 20 V. Electrolysis may be conducted at current densities ranging from about 150 A/m² to about 9,000 A/m², and preferably from about 3,000 A/m² to about 7,000 A/m². In order to reduce CO₂ emissions to the atmosphere and maximize the CDR potential of the process, some or all of the electricity used in the electrolysis is derived from low- or non-CO₂ emitting sources such as from wind, solar, nuclear and hydro sources.

The magnesium hydroxide 248 produced by electrolysis has been used to capture and permanently sequestrate carbon dioxide from air (CDR/OAE) or as contained in a flue gas stream or parcel (CCS). CO₂ capture with permanent sequestration has been realized by counter-current contacting a slurry of particulate and dissolved magnesium hydroxide (hereafter called pulp) with an incoming gas stream containing carbon dioxide. More advantageously, the counter-current contacting occurs at pulp solids concentrations ranging from about 10 to about 50% wt. and preferably from about 15 to about 35% wt. The rotational speed of the impeller ranges from about 150 rotations per minute to about 600 rotations per minute, and preferably from about 150 rotations per minute to about 300 rotations per minute. The purity of the magnesium hydroxide has ranged from about 75% to about 100%, and preferably from about 85% to about 100%. The concentration of carbon dioxide in the gaseous stream has ranged from about 0.01% to about 100% volume/volume, also known as “on volume basis” and preferably from about 70% to about 100% volume/volume. The stoichiometry molar excess coefficient of the carbon dioxide versus magnesium hydroxide across the plurality of counter-current contacting stages has varied from about 0.01 to about 1.2, and preferably from about 0.05 to about 0.9. The process temperature has ranged from about 15° C. to about 90° C., and preferably from about 20° C. to about 60° C. The residence time of the pulp flowing in counter-current with the gaseous stream has ranged from about 3 hours to about 12 hours, and preferably from about 2 hours to about 8 hours.

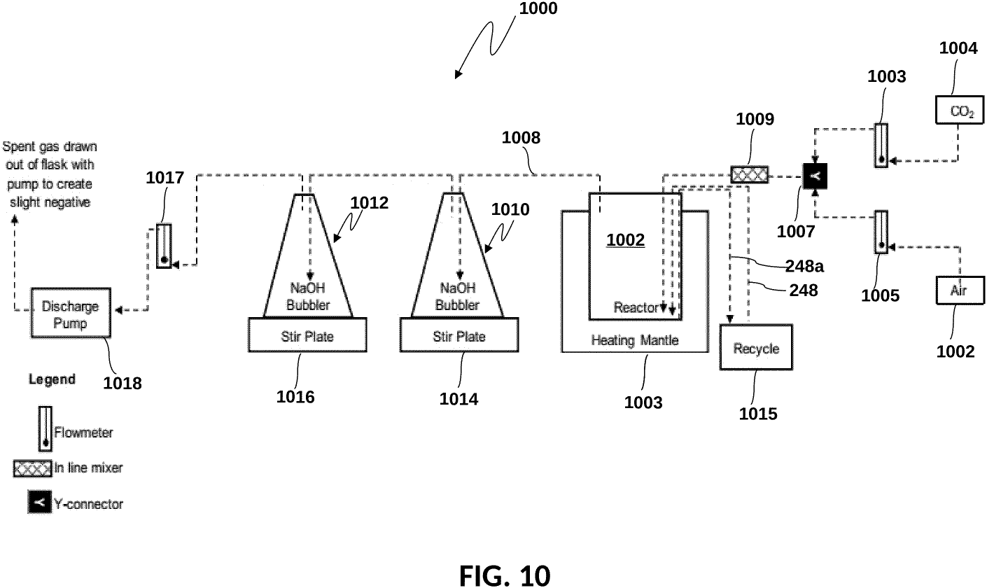

FIG. 10 shows an experimental apparatus 1000 for investigating CO₂ capture from a CO₂-rich gas stream using magnesium hydroxide pulp 248 from the system of FIG. 1. The apparatus includes an agitated reactor 1002 having, for example 4L capacity and a heating mantle 1003, and containing the magnesium hydroxide pulp 248 at about 15% wtm. A mixture of carbon dioxide 1004 and air 1006 at pre-determined compositions are sparged, via corresponding flow-meters 1003 and 1005, Y-connector 1007 and in line mixer 1009, into the agitated reactor 1002 at pre-determined flow rates. The un-reacted CO₂ 1008 is scrubbed in a series of scrubbers, for example NaOH Bubbler 1010 and NaOH Bubbler 1012, using a sodium hydroxide solution. Each of the NaOH Bubbler 1010 and 1012 has about 4L filter flask filled with about 3.5L NaOH at about 20% concentration, and corresponding stir plates 1014 and 1016. The bubbler-reaction products, containing NaHCO_{3aq} and Na₂CO_{3aq} are analyzed and included in the overall carbon mass balance.

Also, the magnesium hydroxide pulp 248 is recycled internally (arrow 248a, box 1015) and supplied back to the agitated reactor 1002 (arrow 248).

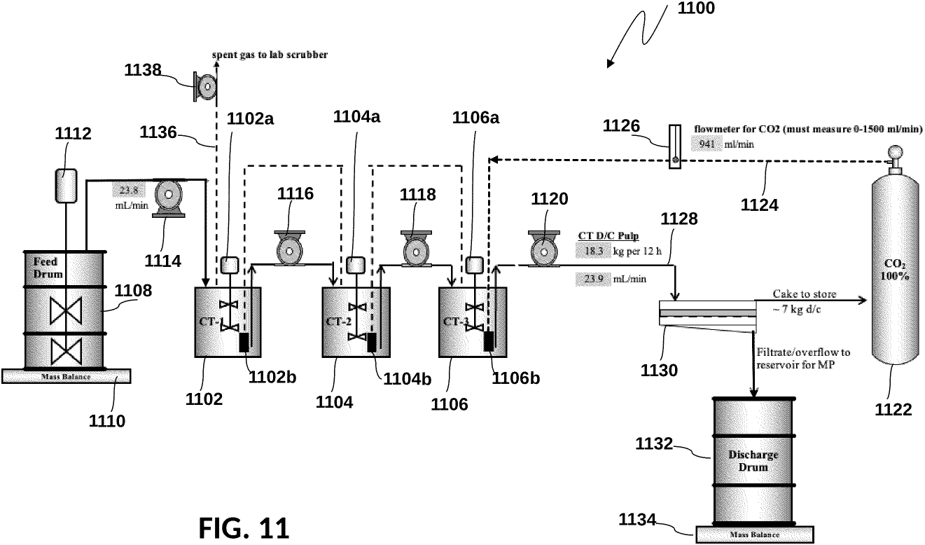

FIG. 11 shows an experimental setup 1100 for continuous CO₂ capture and storage system via magnesium hydroxide pulp carbonation. The experimental setup 1100 has been used to determine the CO₂ absorption efficiencies and assess the overall carbonation potential of magnesium hydroxide pulp in a simulated continuous environment. The experimental setup 1100 includes a circuit of three cascade reactors or scrubbers 1102, 1104 and 1106 each also to be referred to as a carbonation tank (CT), fitted with respective agitation 1102a, 1104a and 1106a, gas sparging, pH, flow rate and temperature monitoring systems(not shown in FIG. 11). Each reactor 1102, 1004 and 1006 has capacity of about 4L, operates at about 20° C., pH of about 9-10 within the reactor, and one cycle scrubbing time of about 2.1 hr.

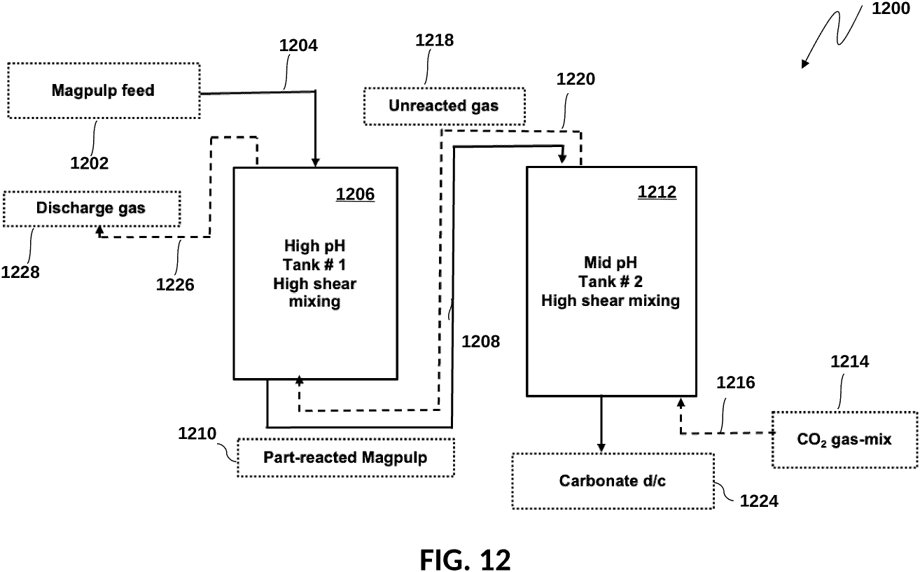

The Critical Solids Density defined the magnesium hydroxide pulp solids content for the continuous operation at about 12% wt. solids content and ran at an average flow rate through the system of 1.49 kg/hr. The operation was performed for 40 hours of actual feeding time, plus start-up and shut down times. The experimental setup 1100 was operated in a counter-current configuration, (as will be described in conjunction with FIG. 12 below) with fresh magnesium hydroxide pulp being fed from a reservoir or feed drum 1008 having mass balance 1010 and agitator 1012, through the reactors CT-1 1002, CT-2 1004, and then CT-3 1006 using corresponding pumps 1114, 1116, 1118 and 1120.

Meanwhile, a substantially pure CO₂ gas 1122 of about 99%-100% concentration was fed in the opposite direction (arrow 1124), from reactors 1006 CT-3, 1004 CT-2 to 1002 CT-1 and progressively absorbed as schematically indicated by spargers 1102b, 1104b and 1106b respectively at predetermined flow rates that correspond to varying stoichiometric ratios ranging from about K=0.9 through about K=0.05 of magnesium hydroxide to CO2. The spargers 1102b, 1104b and 1106b are used for the dispersion of the CO2 into the mixing slurry.

The flow rates were measured by a flow meter 1126 capable of measuring flow rates from about 0 to about 1500 ml/min, and the flow rate in the experiments was about 941 ml/min.

The carbonated magnesium hydroxide pulp 1128 from the reactor 1106 CT-3 is further directed to filtration 1130 and storage in a discharge drum 1132 having a mass balance 1134. The residual CO₂ gas from the reactor 1102 CT-1 is pumped out (arrow 1136) by pump 1138, for example to a lab scrubber (not shown).

The results from the above experiment have indicated that regardless of the flow rate, almost all CO₂ absorption took place in one reactor, 1106 CT-3, where the fresh CO₂ 1122 has contacted the discharge magnesium hydroxide pulp stream. Therefore, since one reactor 1106 has done a majority of the work, it has been determined that only a two-stage scrubbing system is required for certain industrial deployments. At the same time, those familiar with the art will recognize that the number of absorption stages can be adjusted in function of related parameters including but no limited to capture target, tank sizes, available footprint, etc.

FIG. 12 illustrates a two-stage counter-current carbon dioxide removal scrubbing system and corresponding operation. While FIG. 11 is an experimental setup, FIG. 12 illustrates an industrial design/version 1200 of the counter-current scrubbing system built upon the experimental findings of FIG. 11.

In similar fashion to the three stage reactor system 1100 of FIG. 11, the two stage industrial scrubbing system 1200 of FIG. 12 has been designed to operate in a counter-current arrangement with fresh magnesium hydroxide pulp 1202 being fed (arrow 1204) to Stage 1 (1206, Reactor/Tank #1 with high pH and high shear mixing), followed by further supplying (arrow 1208) a partially reacted magnesium hydroxide pulp 1210 to Stage 2 (1212, Reactor/Tank #2 with mid pH and high shear mixing).

CO₂ gas 1214 is being fed (arrow 1216) to the Stage 2 (1212) and contacted with the discharge 1210, partially reacted magnesium hydroxide pulp from the Stage 1 (1208). Then any unreacted CO₂ 1218 is then fed back (arrow 1220) to the Stage 1 (1206) where it contacts with fresh magnesium hydroxide 1202. As in previous experimental test work of FIG. 11, the industrial system 1200 is designed in a way that Stage 2 (1212) will do most of the CO₂ capture and storage, releasing the stored carbon as magnesium carbonate 1224. Meanwhile, Stage 1 (1206) acts as a scavenging scrubber, absorbing any unreacted CO₂ and releasing (arrow 1226) the CO₂-free discharge gas 1228.

In the system 1200 of FIG. 12, the flow rates (or stoichiometric ratios, K, of CO₂ to magnesium hydroxide) and the residence times within each stage are optimized to maximize the carbonation efficiencies and magnesium hydroxide usage. Stage 1 (1206) is designed to operate at about K=0.12, with a residence time of about 2.4 hours, and Stage 2 (1212) at about K=0.94 with a residence time of about 4.8 hours.

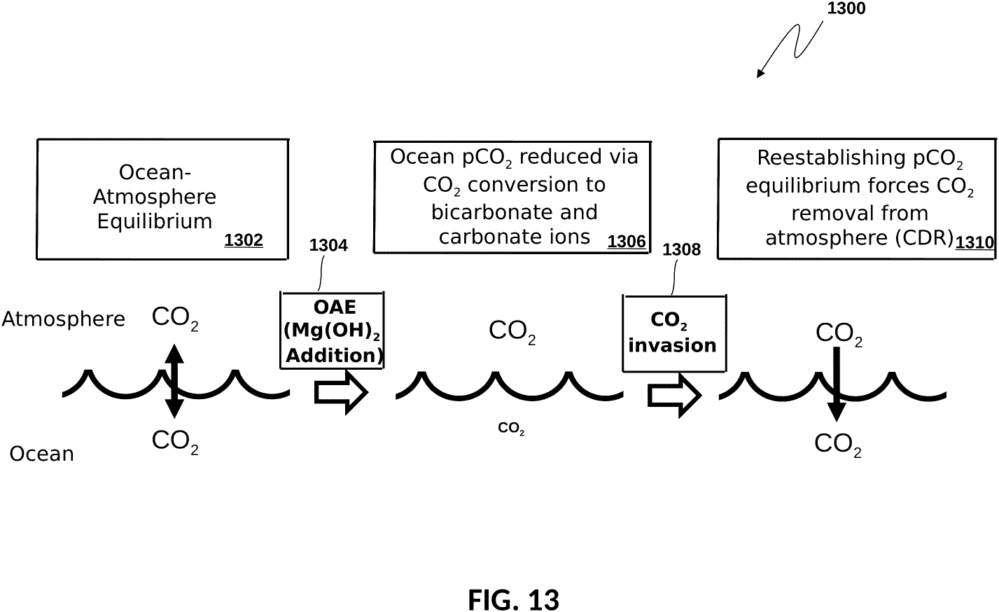

FIG. 13 shows a diagram 1300 schematically illustrating ocean alkalinity enhancement, applied to surface ocean waters in contact with the atmosphere.

The magnesium hydroxide produced by electrolysis has been used to capture and permanently sequestrate carbon dioxide present in water. In the ocean-atmosphere equilibrium state 1302, a partial pressure of CO₂ in the air is balanced by the partial pressure of the CO₂ in the ocean.

Upon addition of magnesium hydroxide to seawater 1304, magnesium hydroxide dissociates into Mg²⁺ and OH⁻, with the latter consuming dissolved CO₂ to form magnesium bicarbonate and some carbonate ions: Mg(OH)₂ + ACO_{2aq} → Mg²⁺ + B(HCO₃⁻) + C(CO₃²⁻) where A ranges from about 1.6 to 1.7 (molar multiplier) as dictated by seawater pH, and where A=B+C and B>C at typical seawater pH ranges. This consumption of dissolved seawater CO₂ alters the local ocean-atmosphere CO₂ pressure gradient 1306. Depending on the ambient seawater conditions prior to Mg(OH)₂ addition, this change in pressure gradient will either: a) induce atmospheric CO₂ uptake from the overlying air or gas 1308, b) increase ambient rates of CO₂ uptake from the overlying air or gas 1308, or c) reduce the rate of CO₂ outgassing from the ocean in areas where gas pressure of CO₂ in seawater is already higher than in the overlying gas or air, for example, ocean upwelling areas or near wastewater outfalls (not shown).

Regardless of these scenarios, the net result is a reduction of the carbon dioxide burden in the overlying air or gas via i) forcing the removal of the CO₂ from the atmosphere and an increase in the inorganic carbon content of the seawater (CDR; 1310), or ii) a reduction in CO₂ emissions from the ocean and retention of seawater inorganic carbon relative to non-alkalized conditions (not shown).

In order to maximize the reduction of the atmospheric CO₂ burden by the methods and systems of the present invention, some or all of the energy used to produce, purify and distribute the magnesium hydroxide is derived from low- or non-CO₂ emitting sources that include but are not limited to wind, solar, geothermal, biomass, nuclear and hydro sources of energy generation.

The chemical reactions underlying to the above described Heap/Vat Leaching Circuit 100, Impurity Precipitation and Removal Circuit 200, Electrolysis Circuit 300 and CO₂ removal and storage schemes are listed below:
Equation 1: Magnesium Leaching from Silicates

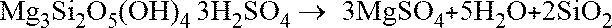

Equation 2: Nickel and Magnesium Leaching from Garnierite

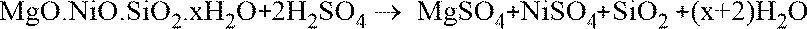

Equation 3: Calcium Dissolution from Oxides

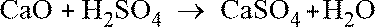

Equation 4: Cobalt Dissolution from Oxides

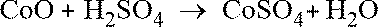

Equation 5: Ferric dissolution from Oxides

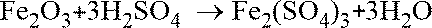

Equation 6: Ferrous dissolution from Oxides

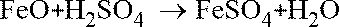

Equation 7: Aluminum Dissolution from Oxides

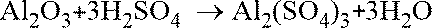

Equation 8 Iron oxidation and subsequent hydrolytic precipitation

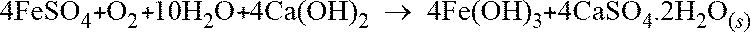

Equation 9 Aluminum Precipitation

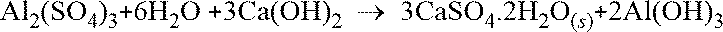

Equations 10 and 11 Nickel and Cobalt Precipitation

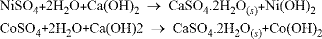

### Electrochemical Reactions

### Anode Half-Reaction

Equation 12 Main:

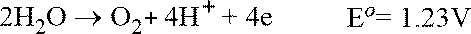

Equation 13 Cathode half-reaction

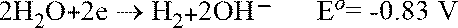

Equation 14 and 15 Overall electrochemical and subsequent chemical reactions:

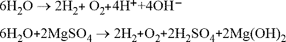

Equation 16 Point-source carbon capture to form magnesite (MgCO₃)

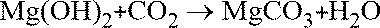

Equation 17 Carbon Sequestration via Ocean Alkalinity Enhancement

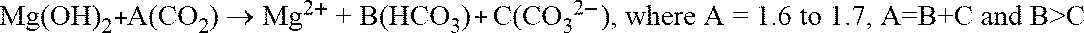

### EXPERIMENTAL EXAMPLES

Experimental examples presented below are non-limiting, and are used to better exemplify the processes of the present invention.

### Example 1

Example 1 illustrates the application of heap leaching to a representative sample of asbestos tailings. The tailings predominantly contain magnesium (22-23% by weight Mg), silica (18-19% Si) and iron (5% Fe) with minor elements such as nickel (0.2% Ni), and cobalt (0.01% Co). The elemental chemical composition of the tailings suggests that the magnesium in the tailings is predominantly deported to a silicate host mineral (Mg₃Si₂O₅(OH)₄).

The test setup is illustrated in FIG. 4. The testing protocol involved charging about 36 kg of tailings with 6% wt. moisture into a column of 179 cm height and 15 cm diameter. Irrigation has been realized by pumping the lixiviant solution 154 containing about 7 wt% H₂SO₄ onto the top of the column at a flowrate of about 3.5 mL/min corresponding to about 0.2 L/min.m² irrigation rate. The lixiviant 154 has been recirculated until its pH has reached a value of about 2.5. Fresh lixiviant has been added gradually in order to maintain the leaching kinetics until the reaction progressed at increasing cumulative rate. The column-simulated heap leaching has been continued until metal extractions plateaued after about 70 days of leaching. The column 140 has been washed until the wash water has reached a pH value of about 4.

The metal extractions such as Mg, Fe, Ni and Co are about 90%, 53%, 92% and 86%, respectively relative to that contained in the original tailings.

The metallurgical balance has indicated a complete asbestos removal in the solid samples withdrawn from the top of the column, while the asbestos content in the solid sample collected from the bottom of the column was about 15% in the head sample. This corresponds to an 81 wt% asbestos reduction for a magnesium extraction extent of 90%. The results are summarized in Table 1 below.

TABLE 1

Column-simulated heap leaching results summary - 1.8 m height. Feed % and residue % are by weight.

| Stream | Mg | Si | Al | Ni | Co | Ca | Fe | Asbestos |
|---|---|---|---|---|---|---|---|---|
| Leaching, analyses in units as shown | | | | | | | | |
| Feed, % | 22.7 | 18.7 | 0.48 | 0.17 | 0.01 | 0.19 | 5.11 | 3 |
| PLS, mg/L | 18100 | 143 | 161 | 174 | 8 | 85 | 2400 | - |
| Wash mg/L | 2020 | 63.2 | 13.5 | 22.7 | 1.2 | 10.1 | 178 | - |
| Residue. % | 6.75 | 32.9 | 0.55 | 0.037 | 0.002 | 0.16 | 3.87 | 1 |
| Leaching, extractions, % by method as indicated | | | | | | | | |
| Cale Head | 84 | 1 | 35 | 90 | 74 | 42 | 53 | - |
| Direct Head | 88 | 1 | 36 | 114 | 83 | 41 | 50 | - |
| Feed vs. Residue | 83 | -2 | 33 | 87 | 86 | 53 | 56 | 81 |
| Accountability | 105 | 103 | 103 | 127 | 97 | 89 | 94 | 19 |

### Example 2

Example 2 illustrates the scale-up of heap leaching to a representative sample of asbestos tailings of a composition comparable to the sample in the previous example #1. The test used the same setup as illustrated in FIG. 4 but at significantly larger scale. The testing protocol involved charging about 861 kg of tailings with 6% wt. moisture into a column of 5.8 m height and 38 cm diameter. Irrigation has been realized by pumping the lixiviant solution 154 containing about 15 wt% H₂SO₄ onto the top of the column 142 at a flowrate of about 48 mL/min corresponding to about 0.4 L/min.m² irrigation rate. The lixiviant 154 has been recirculated until its pH has reached a value of about 2.5. The pregnant leach solution 158 was recycled to allow maximum extraction efficiency and the magnesium tenor. Fresh lixiviant has been added gradually in order to maintain the leaching kinetics until the reaction progressed at increasing cumulative rate. The column-simulated heap leaching has been continued until metal extractions plateaued after about 107 days of leaching. The column has been washed until the wash water has reached a pH value of about 3.3.

The final metal extractions for Mg, Fe, Ni and Co have been about 93, 83%, 92 and 89%, respectively, of that contained in the original tailings.

The metallurgical balance indicated complete asbestos removal in the entire mass of the leached residue. The results are summarized in Table 2 below.

TABLE 2

Column-simulated heap leaching results summary - 5.8 m height

| Stream | Mg | Si | Al | Ni | Co | Ca | Fe | Asbestos |
|---|---|---|---|---|---|---|---|---|
| Leaching, analyses in units as shown | | | | | | | | |
| Feed, % | 23.6 | 17.6 | 0.33 | 0.20 | 0.01 | 0.26 | 5.36 | 17 |
| PLS, mg/L | 36,792 | 63 | 228 | 309 | 13 | 232 | 7,241 | - |
| Wash, mg/L | 3,090 | 64 | 14 | 43 | 2 | 29 | 529 | - |
| Residue, % | 6.75 | 32.9 | 0.55 | 0.037 | 0.002 | 0.16 | 3.87 | 0 |
| Leaching, extractions, % by method as indicated | | | | | | | | |
| Calc Head | 93 | 0 | 42 | 92 | 89 | 53 | 83 | - |
| Direct Head | 92 | 0 | 41 | 92 | 86 | 52 | 80 | - |
| Feed vs. Residue | 93 | 0 | 45 | 92 | 90 | 54 | 84 | ~100 |
| Accountability | 99 | 100 | 96 | 100 | 96 | 98 | 96 | - |

### Example 3

Example 3 illustrates the application of vat leaching of a representative sample of asbestos tailings from the same source on which the heap-leaching simulation was performed. The test setup is illustrated in FIG. 5.

The testing protocol involved charging about 36 kg of tailings with an average moisture content of 5.9 wt% into a column of 168.5 cm height and 15 cm diameter. Percolation has been realized by pumping the lixiviant solution 154 containing about 7 wt% H₂SO₄ into the bottom of the column at a flowrate of about 16 mL/min corresponding to about 0.4 L/min.m² percolation rate. The lixiviant has been recirculated unit its pH has reached a value of about 2.5. Fresh lixiviant has been added gradually in order to maintain the leaching kinetics until the reaction progressed at increasing cumulative rate. The column-simulated vat leaching has been continued until metal extractions plateaued after about 35 days of leaching. The column 142 has been washed until the wash water has reached a pH value of about 4.

The results are summarized in Table 3 below.

TABLE 3

Column-simulated vat leaching results summary

| Stream | Mg | Si | Al | Ni | Co | Ca | Fe | Asbestos |
|---|---|---|---|---|---|---|---|---|
| Analyses, units as shown | | | | | | | | |
| Feed, % | 22.7 | 18.7 | 0.48 | 0.17 | 0.01 | 0.19 | 5.11 | 3 |
| PLS, mg/L | 11700 | 110 | 105 | 123 | 6 | 68 | 1750 | |
| Wash, mg/L | 1770 | 59.5 | 23.5 | 10.3 | 0.6 | 6.8 | 712 | |
| Residue, % | 9.89 | 29.7 | 0.56 | 0.048 | 0.003 | 0.19 | 4.53 | 4 |
| Extractions, % | | | | | | | | |
| Calc Head | 79 | 2 | 39 | 88 | 66 | 41 | 60 | – |
| Direct Head | 93 | 1 | 42 | 122 | 83 | 48 | 76 | – |
| Fd vs Res | 75 | 10 | 33 | 84 | 82 | 43 | 50 | 24 |
| Accountability | 118 | 92 | 109 | 138 | 101 | 105 | 126 | 76 |

### Example 4

Example 4 illustrates the application of two-stage counter-current vat leaching to a representative sample of asbestos tailings from the same source on which the heap-leaching simulation was performed. The test has used the same setup as illustrated in FIG. 5 but at significantly larger scale.

The testing protocol involved charging about 35 kg of tailings with an average moisture content of 5.9 wt% into a column of 170 cm height and 14 cm diameter. First stage-leach percolation has been realized by pumping the partly-depleted lixiviant solution containing about 15 wt% H₂SO₄ into the bottom of the column at a flowrate of about 19 mL/min corresponding to about 1.2 L/min.m² percolation rate. The first stage-leaching was completed in about 7 days during which the pH of the pregnant leach solution has reached 1.8. The column was drained, and the residue washed. The washed residue was subjected to the second-stage leach with a fresh lixiviant solution containing about 21 wt% H₂SO₄. The second-stage leaching was conducted for about 21 days of leaching, when the residue was washed, discharged, weighed, and analyzed.

The results are summarized in Table 4 below.

TABLE 4

Column-simulated two-stage counter-current vat leaching results summary

| Stream | Mg | Si | Al | Ni | Co | Ca | Fe |
|---|---|---|---|---|---|---|---|
| Analyses, Counter-current Stage 1, units as shown | | | | | | | |
| Feed, % | 22.4 | 16.9 | 0.28 | 0.20 | 0.01 | 0.19 | 5.22 |
| PLS, mg/L | 37,422 | nd | 57 | 329 | 16 | 321 | 2,832 |
| Wash, mg/L | 5,328 | nd | 1 | 45 | 2 | 69 | 142 |
| Residue, % | 20.12 | 21.2 | 0.34 | 0.181 | 0.009 | 0.16 | 6.00 |
| Extractions, %, Counter Current Stage 2 | | | | | | | |
| Calc Head | 23.5 | 15.0 | 0.3 | 0.2 | 0.0 | 0.1 | 4.8 |
| Direct Head | 27.2 | 0.0 | 3.1 | 25.8 | 31.2 | 63.1 | 9.3 |
| PLS vs. Feed | 25.5 | 0.0 | 3.1 | 25.1 | 24.0 | 26.1 | 8.3 |
| Accountability | 105 | 89 | 101 | 109 | 83 | 48 | 92 |
| Analyses, Counter-current Stage 2, units as shown | | | | | | | |
| Feed, % | 20.1 | 21.2 | 0.34 | 0.18 | 0.01 | 0.16 | 6.00 |
| PLS, mg/L | 53,275 | | 387 | 754 | 24 | 204 | 7,823 |
| Wash, mg/L | 1,498 | | 7 | 20 | 1 | 13 | 144 |
| Residue, % | 12.16 | 24.4 | 0.32 | 0.054 | 0.005 | 0.13 | 5.40 |
| Extractions, %, Counter Current Stage 2 | | | | | | | |
| Calc Head | 23.4 | 20.6 | 0.4 | 0.2 | 0.0 | 0.2 | 6.2 |
| Direct Head | 43.5 | 0.0 | 15.7 | 75.2 | 84.5 | 15.2 | 20.9 |
| PLS vs. Feed | 47.3 | 0.0 | 18.6 | 74.1 | 50.3 | 28.4 | 21.6 |
| Accountability | 116 | 97 | 111 | 102 | 59 | 136 | 104 |
| Key overall Extractions, %, Two-stage Counter Current Leaching | | | | | | | |
| Calc Head | 72.8 | | | 99.2 | | | |
| Direct Head | 61.4 | | | 99.9 | | | |
| PLS vs. Feed | 61.4 | | | 86.6 | | | |

### Example 5

Example 5 illustrates the removal of iron and other impurities from the pregnant leach solution.

The removal of iron and accompanying impurities has been demonstrated using tests-samples of about 2 L pregnant leach solution produced by the heap leach column simulation test of FIG. 4. Oxygen has been sparged at a volume flow rate of 1200 mL/min into the agitated reactor. The pH has been maintained continuously at 4.6 by controlled additions of about 20% wt. calcium hydroxide slurry. The reaction temperature has been increased from about 25° C. to about 85° C. during the about 3 hours test-duration. The experimental conditions and results are shown in Table 5 below.

TABLE 5

The impurity removal-conditions and results

| Test ID | Feed PLS L | Time h | Reagent dosage | | | | Recovery (precipitated) | | | | |
|---|---|---|---|---|---|---|---|---|---|---|---|
| | | | Ca(OH)₂ g/L feed | Ca(OH)₂/ (Fe+Al) mol/mol ) | O₂ L/min | H₂O₂ g/L feed | Fe % | Al % | Mg % | Ni % | Co % |
| P4 | 2.0 | 3.8 | 7.7 | 2.1 | 1.2 | 0.0 | 100 | 99.9 | 1.8 | 26.2 | 19.3 |
| IR4 | 2.5 | 1.4 | 18.5 | 2.4 | 1.2 | 0.7 | 100 | 99.7 | 3.5 | 11.6 | 9.0 |
| Test ID | Solution composition | | | | | Precipitate composition | | | | | |
| | Fe mg/L | Al mg/L | Mg mg/L | Ni mg/L | Co mg/L | Weight g/L feed | Fe % | Al % | Mg % | Ni % | Co % |
| P4 | <1 | <0.2 | 18900 | 134 | 6.9 | 19.4 | 12.3 | 0.93 | 1.6 | 0.22 | 8E-03 |
| IR4 | <1 | <0.4 | 34700 | 303 | 14.6 | 54.7 | 10 | 0.25 | 2.2 | 0.07 | 3E-03 |

### Example 6

Example 6 illustrates the production of a mixed nickel-cobalt hydroxide precipitate (“MHP”) from the barren solution produced by a preceding iron and other impurities removal test of the example #5.

The precipitation of nickel and cobalt has been realized at ambient temperature by dosing about 25% wt. calcium hydroxide slurry in test labeled as “P5” in Table 6 below, and and 20% MgO slurry in test lebeld as “P6” in the Table 6 below. The pH was maintained between about 8.5 in P5 experiment for 1.1h. The products were filtered. The filtrate was further treated with calcium hydroxide slurry to pH 9.1 for 2.4 hours to improve Ni recovery into a precipitate. Using MgO in MHP (mixed hydroxide precipitation) experiment at pH8.8 was successful to recover most of Ni in one stage treatment. The composition of the precipitated residue is summarized in Table 6 below.

TABLE 6

The Ni and Co recovery -conditions and results

| Test | Feed | Time | Temp. | Reagent dosage | | Solution composition | | | | Recovery | | |
|---|---|---|---|---|---|---|---|---|---|---|---|---|
| | PLS | | | Ca(OH)₂ | MgO | pH | Mg | Ni | Co | Mg | Ni | Co |
| ID | L | h | oC | g/L feed | g/L | | mg/L | mg/L | mg/L | % | % | % |
| Feed-1 | | | | | | 4.4 | 18167 | 143 | 7.00 | | | |
| P5 | 3.0 | 1.1 | 23 | 0.9 | 0.0 | 8.3 | 17600 | 23.9 | 0.5 | 0.3 | 80.2 | 92.5 |
| P6 | 2.6 | 2.4 | 23 | 0.2 | 0.0 | 9.1 | 16600 | 2.0 | <0.3 | 0.14 | 87.6 | 47.4 |
| P5+P6 | - | 3.5 | - | 1.1 | 0.0 | - | - | - | - | 0.3 | 88.5 | 94.8 |
| Feed-2 | | | | | | 4.3 | 35200 | 241 | 12.2 | | | |
| MHP | 2.0 | 3.4 | 44 | 0.0 | 0.9 | 8.8 | 33200 | 5.9 | <0.3 | 0.3 | 98.1 | 97.8 |

### Example 7

Example 7 illustrates experimental results for a two-compartment electrolysis cell for conducting electrolysis of a magnesium sulphate solution for generating the sulfuric acid for leaching while producing magnesium hydroxide for carbon capture. The electrolysis also produces oxygen that is used in the metallurgical process as outlined in this overall description and shown FIGS. 1, 8 and 98. The experimental test setup corresponds to the prior art and not illustrated in the present application. The experimental setup in the Example #7 is similar to the electrolysis cell 302a of FIG. 8, except for having two-compartments with a single separator/diaphragm instead of three-compartments and two separators in FIG. 8.

The electrolysis has been conducted using a diaphragm with a permeability of about 4 NLdm⁻²min⁻¹. The catholyte contained about 80 g/L MgSO₄ for both tests labeled as “Mg7” and “Mg10” in the Table 7 below. The anolyte contained about 50 g/L H₂SO₄ in the test Mg7, and about 70 g/L H₂SO₄ in the test Mg10. The test-temperature averaged about 30° C. for both tests. The current density has been about 381 A/m² for the test Mg7, and about 907 A/m² for the test Mg10. The current efficiencies estimated based on the 88% purity of the magnesium hydroxide produced in both tests have been about 44% and about 66% for the tests Mg7 and Mg10, respectively. The results indicated that at comparable energy consumption values, practically near the margin of error, the amount of magnesium hydroxide produced increased by about 188% from the test Mg7 to the test Mg10. The results are summarized in Table 7 below.

TABLE 7

Comparative two-compartment electrolysis tests results summary

| Test | Current | | | Grams produced, pure equivalents of | | | | Energy consumption | |
|---|---|---|---|---|---|---|---|---|---|
| ID | A | V | A/m² | H₂ | O₂ | H₂SO₄ | Mg(OH)₂ | kWh | MWh/t OH⁻ |
| Mg 7 | 8.0 | 8.1 | 381 | 1.5 | 23.9 | 54.5 | 19.1 | 0.3 | 29 |
| Mg 10 | 19.1 | 13.2 | 907 | 2.9 | 45.7 | 88.0 | 54.8 | 1.0 | 32 |

### Example 8

Example 8 illustrates experimental results for the three-compartment electrolysis cell 302b but with two cathodes and a single anode in between as shown in FIG. 9. In addition, the compartments in the cell was separated with a lower permeability diaphragm 0.76 Nldm⁻²min⁻¹. The catholyte contained about 193 g/L MgSO₄ for both tests. The anolyte contained about 50 g/L H₂SO₄ in the test labeled as “e2-Mg22” test in the Table 8 below, and about 55 g/L H₂SO₄ in the test labeled as “e2-Mg23a” in the Table 8 below. The test temperature has averaged about 20° C.-35° C. for both tests. The current density has been about 1350 A/m² for both tests. The current efficiencies estimated were 75.2% in the e2-Mg22 test based on estimated 93.9% purity and 92.5% in the e2-Mg23a test based on the 95.5% purity of the magnesium hydroxide. The results indicated less energy consumption values and larger amount of production rate at selected conditions. The results are summarized in Table 8 below.

TABLE 8

Three-compartment electrolysis with two cathode and a single anode- tests summary

| Test | Current | | | Grams produced, pure equivalents of | | | | Energy consumption | |
|---|---|---|---|---|---|---|---|---|---|
| ID | A | V | A/m² | H₂ | O₂ | H₂SO₄ | Mg(OH)₂ | kWh | MWh/t OH⁻ |
| e2-Mg22 | 54.0 | 7.9 | 1350 | 11.6 | 183.9 | 473 | 252 | 2.4 | 18 |
| e2-Mg23a | 54.0 | 8.6 | 1350 | 10.2 | 161.2 | 428 | 284 | 2.3 | 15 |

### Example 9

Example 9 illustrates the three-compartment electrolysis cell of FIG. 8 using lower permeability diaphragms 0.76 NLdm⁻²min⁻¹. The anolyte contained about 20 g/L H₂SO₄. The catholyte and middle compartment contained about 180-190 g/L MgSO₄. The magnesium sulphate was added into the middle compartment at 2-2.5 mL/min. The test labeled “e2-Mg12” test in Table 9 below was run at 22° C., and the test labeled “e2-Mg16” in the Table 9 below was run at 53° C. The current density was 450 A/m² in the test e2-Mg1, and 1350 A/m² in the test e2-Mg16. The current efficiencies estimated were 94% in the test e2-Mg12 based on estimated 93.4% purity, and 98.7% in the test e2-Mg16 based on the 94.4% purity of the magnesium hydroxide. The results have indicated relatively less energy consumption values at lower current densities (test e2-Mg12) and larger amount of magnesium hydroxide product collected at higher current density experiment (test e2-Mg16). The results are summarized in Table 9 below.

TABLE 9

Three-compartment electrolysis tests summary

| Test | Current | | | Grams produced, pure equivalents of | | | | Energy consumption | |
|---|---|---|---|---|---|---|---|---|---|
| ID | A | V | A/m² | H₂ | O₂ | H₂SO₄ | Mg(OH)₂ | kWh | MWh/t OH⁻ |
| e2-Mg12 | 9.0 | 7.0 | 450 | 1.4 | 21.5 | 57 | 37 | 0.3 | 12 |
| e2-Mg16 | 27.0 | 10.1 | 1350 | 5.1 | 80.6 | 244 | 145 | 1.4 | 16 |

### Example 10

Example 10 illustrates the magnesium hydroxide pulp carbonation process as batch mode.

Counter-current contacting a magnesium hydroxide containing pulp with an incoming stream containing carbon dioxide has been simulated in batch mode. Prior to the tests, the flow-response of the magnesium hydroxide pulp has been determined through rheology measurement. Accordingly, concentric cylinder rotational viscometry test-results have determined the critical solids density of about 15% wt. solids suitable for the test.

The rotational speed of the impeller was about 200 rotations per minute. The purity of the magnesium hydroxide was about 89%. The concentration of carbon dioxide in the gaseous stream was about 99% volume/volume. The stoichiometry excess coefficient of the carbon dioxide versus magnesium hydroxide across four counter-current contacting stages, identified in the Table 10 below as CT5, CT6, CT7 and CT8, was varied from about 0.05 to about 0.9. The process temperature has been about 24° C. The residence time of the pulp flowing in counter-current with the gaseous stream has been about 6.3 hours. The test setup is illustrated in FIG. 10.

The reaction progress has been assessed based on slurry kinetics samples, with inorganic carbon analyzed in both the liquid and solids phases. In addition, titration of the sodium hydroxide (20% NaOH) scrubber has been performed for carbon-balance closure. Metallurgical balance has been performed around each test comprising the four-tests sequence of a total duration of about 105 minutes. The results, summarized in Table 10 below, have confirmed practically a total carbon dioxide removal and sequestration from the incoming gaseous stream under the simulated steady-state conditions.

TABLE 10

Batch carbonation tests summary

| Test ID | Carb on dioxide gas st Equivalent CO₂ ream | | | Actual elapsed | CO₂ absorption | | |
|---|---|---|---|---|---|---|---|
| | | | | | Rate | Restime | Efficiency |
| <-> | K | % vol. CO₂ | NL/min | min | %/h | hours | % |
| CT5 | 0.9 | 99 | 6.4 | 30 | 4.7 | 1.6 | 7.3 |
| CT6 | 0.5 | | 1.8 | 60 | 9.9 | 1.6 | 15.6 |
| CT7 | 0.1 | | 0.24 | 90 | 42.3 | 1.6 | 66.3 |
| CT8 | 0.05 | | 0.10 | 105 | 63.7 | 1.6 | 99.99 |

### Example 11

Example 11 shows experimental results for the magnesium hydroxide pulp carbonation process in continuous mode.

Counter-current contacting a magnesium hydroxide containing pulp with an incoming stream containing carbon dioxide has been simulated in continuous mode. Prior to the tests, the flow-response of the magnesium hydroxide pulp has been determined through rheology measurement. Accordingly, concentric cylinder rotational viscometry test-results have determined the critical solids density of about 12% wt. solids suitable for the test. Except for the continuous flowrate, the operating conditions of the individual reactors were similar to the batch-conditions used for the scale up.

The continuous setup contained a circuit of three cascade reactors fitted with agitation, gas sparging, pH, flow rate and temperature monitoring systems. The carbon dioxide was contacted in counter-current at flow rates defined based on the target-excess of CO₂ vs. the pure-equivalent Mg(OH)₂ content of the slurry-flow. The test setup is illustrated in FIG. 11.

The results were used to scale up, as summarized in Table 11 below. The results have confirmed practically a total carbon dioxide removal and sequestration from the incoming gaseous stream under the actual continuous operating conditions.

TABLE 11

Data generated continuous carbonation scale up criteria

| Stage # | K Stage | Carbonation efficiency, % Stage Cum’ve | | Carbon dioxide flowrate kg CO₂/t MH kg CO₂/t MH/h | | Restime Hours |
|---|---|---|---|---|---|---|
| Three-stage counter-current contacting | | | | | | |
| 3 | 0.94 | 96 | 95.8 | 740 | 153 | 4.8 |
| 2 | 0.76 | 53 | 98.0 | 31 | 24 | 1.3 |
| 1 | 0.75 | 53 | 99.1 | 15 | 13 | 1.1 |
| Circuit - overall | | All | 99.1 | 733 | 101 | 7.2 |
| Two-stage counter-current contacting | | | | | | |
| 2 | 0.94 | 95 | 95.0 | 740 | 154 | 4.8 |
| 1 | 0.12 | 94 | 99.7 | 37 | 15 | 2.4 |
| Circuit - overall | | All | 99.7 | 737 | 102 | 7.2 |

Intermediate stage-efficiencies and K values calculated from the data-generated regression equations.

### Example 12

Example 12 demonstrates the CO₂ capture process in seawater via the addition of magnesium hydroxide illustrated in FIGS. 13 and 14. 117 mg of powdered Mg(OH)₂ was added to a beaker containing 2L of rapidly stirred seawater and open to air, resulting in a very dilute Mg(OH)₂+seawater “slurry”. After 13 days the seawater’s total dissolved inorganic carbon has increased by 72%, reflecting the transfer and permanent storage of CO₂ from the overlying air to the seawater. The pH of the seawater has increased by 0.35 units during the 13 day period, thus also demonstrating that such alkalinity addition can help counter ocean acidification.

Although specific embodiments of the invention have been described in detail, it should be understood that the described embodiments are intended to be illustrative and not restrictive. Various changes and modifications of the embodiments shown in the drawings and described in the specification may be made within the scope of the following claims without departing from the scope of the invention in its broader aspect.

What is claimed is:

1. A method for producing a low-CO₂-emissions metal hydroxide and byproducts, comprising:
(a) leaching, using an acid, a mineral rock mass containing one or more metals, thereby forming a leachate containing dissolved metal salts;
(b) separating at least some of the one or more metals from the leachate using a neutralizing agent and oxygen gas;
(c) using a metal salt from the leachate from the step (b) as an electrolyte in an electrolysis cell to produce the oxygen gas, the acid and a metal hydroxide;
(d) supplying the acid produced in the electrolysis cell back to the leaching step (a); and
(e) supplying the oxygen gas produced in the electrolysis cell back to the separating step (b); thereby producing the metal hydroxide and byproducts, the byproducts being the at least some of said one or more metals, the metal, salt, the oxygen gas, and the acid.

2. The method of claim 1, further comprising using the metal hydroxide produced in the step (c) for removing and sequestering carbon dioxide.

3. The method of claim 1 wherein the mineral rock mass contains at least some metal silicate, a metal in the metal silicate being a member of the Group 1 or Group 2 elements of the periodic table, the metal silicate being predominantly a magnesium silicate.

4. The method of claim 1, wherein the mineral rock mass contains a fibrous composition, preferably asbestos fiber, the method further comprising reducing a quantity of the fibrous composition down to a predetermined fiber level via reaction with the acid.

5. The method of claim 3, wherein the rock mass is irrigated with or immersed in the acid, preferably a 2% to 20% concentrated sulfuric acid solution and more preferably a 4% to 12% concentrated sulfuric acid solution such that at least some of the metals contained in the mineral rock mass are leached from the mineral rock mass and converted to dissolved metal salts, preferably dissolved metal sulfates.

6. The method of claim 1, wherein the step (b) comprises adding the metal hydroxide such that a saturation state of at least some of the one or more metals in the leachate is exceeded, thereby precipitating said at least some of the one or more metals from solution as solid metal hydroxide, preferably precipitating nickel, cobalt, iron, chromium.

7. The method of claim 6, wherein a metal in the metal hydroxide being added in the step (b) is a member of Group 1 or Group 2 elements of the periodic table, preferably calcium or magnesium.

8. The method of claim 6, wherein the adding the metal hydroxide comprises adding metal hydroxide sufficient to elevate a pH of the leachate to about 3.8-4.9, and preferably to about 4.4-4.8, for precipitating iron from the leachate as iron hydroxide, followed by further adding the metal hydroxide sufficient to elevate the pH of the leachate to about 8-9.5, and preferably to about 8.5-9.3 for precipitating nickel and cobalt from the leachate as nickel and cobalt hydroxide.

9. The method of claim 1, wherein the electrolysis cell has an anode and a cathode at least partially submerged in an electrolyte solution containing the metal salt, the method further comprising applying across the anode and cathode a direct electric current having a voltage in a range from about 2 V to about 25 V, and preferably 5 V to 20 V, and a current density in a range from about 150 A/m² to about 9000 A/m², and preferably from about 3000 A/m² to about 7000 A/m².

10. The method of claim 1, wherein said metal salt is a member of the Group 1 or Group 2 elements of the periodic table, preferably magnesium sulfate in a concentration from about 40 g/L Mg to about 100 g/L Mg, and more preferably 60 g/L Mg to 80 g/L Mg, and wherein the acid is sulfuric acid.

11. The method of claim 1, wherein said metal hydroxide produced within the electrolysis cell is one or more of the magnesium hydroxide and calcium hydroxide.

12. The method of claim 9, further comprising introducing a membrane between the anode and the cathode, which is semi permeable to ions and water, the membrane having a permeability of about 0.1 dm-²min-1 to about 17 NL dm-²min-¹, and preferably from about 1 dm⁻²min⁻¹ to about 6 NL dm⁻²min-¹.

13. A system for producing a metal hydroxide and byproducts, the system comprising:
(a) a leaching unit for leaching, using an acid, a mineral rock mass containing one or more metals, thereby forming a leachate containing dissolved metal salts;
(b) a processing unit for separating at least some of the one or more metals from the leachate using oxygen gas;
(c) an electrolysis cell, using a metal salt from the leachate from the step (b) as an electrolyte and producing the oxygen gas, the acid and a metal hydroxide;
(d) a first feedback, supplying the acid produced in the electrolysis cell back to the leaching step (a); and
(e) a second feedback, supplying the oxygen gas produced in the electrolysis cell back to the processing unit (b);
thereby producing the metal hydroxide and byproducts, the byproducts being the at least some of said one or more metals, the metal salt, the oxygen gas, and the acid.

14. The system of claim 13, further comprising a carbon capture and sequestration unit using the metal hydroxide produced in the electrolysis cell (c) for removing and sequestering carbon dioxide.

15. The system of claim 13, wherein said mineral rock mass contains magnesium silicate, and is in a form of a pile or heap, or is contained in a vessel or vat allowing an acid solution containing the acid to pass through and contact with said mineral rock mass.

16. The system of claim 13, wherein said acid is sulfuric acid, preferably in a concentration of about 4% to about 12% by weight.

17. The system of claim 16 wherein the acid solution, upon passing through and contacting said mineral rock mass, contains dissolved metal salts including magnesium salts, the system further comprising means for adding the metal hydroxide to the acid solution to elevate a pH of the acid solution so as to precipitate metals other than dissolved metal salt, said other metals containing nickel, cobalt, iron, aluminum and chromium.

18. The system of claim 17, wherein the means for adding comprises means for adding calcium hydroxide or magnesium hydroxide, preferably an about 20% by weight solution of the calcium hydroxide.

19. The system of claim 13, wherein the metal salt in the electrolysis cell is magnesium sulfate in a concentration of about 40-80 g/L Mg, said voltage is greater than about 5 V-20 V, said anode is titanium, and said cathode is stainless steel.

20. The system of claim 17, wherein the means for adding the metal hydroxide comprises means for adding the metal hydroxide sufficient to elevate a pH of the leachate to about 3.8-4.9, and preferably to about 4.4-4.8, for precipitating iron from the leachate as iron hydroxide, further comprising means for adding the metal hydroxide sufficient to elevate the pH of the leachate to about 8-9.5, and preferably to about 8.5-9.3 for precipitating nickel and cobalt from the leachate as nickel and cobalt hydroxide.
